(19) United States
(12) Patent Application Publication
(10) Pub. No.: US 2017/0024660 A1
(43) Pub. Date: Jan. 26, 2017

(54) Methods and Systems for Using an Expectation-Maximization (EM) Machine Learning Framework for Behavior-Based Analysis of Device Behaviors

(71) Applicant: QUALCOMM Incorporated, San Diego, CA (US)

(72) Inventors: Yin Chen, Campbell, CA (US); Vinay Sridhara, Santa Clara, CA (US); Nima Noorshams, Fremont, CA (US)

(21) Appl. No.: 14/806,882

(22) Filed: Jul. 23, 2015

(51) Int. Cl. G06N 99/00

(52) U.S. Cl. CPC G06N 99/005

(57) ABSTRACT

A computing device processor may be configured with processor-executable instructions to implement methods that include using expectation-maximization (EM) machine learning techniques to continuously, repeatedly, or recursively generate, train, improve, focus, or refine the machine learning classifier models that are used by a behavior-based monitoring and analysis system (or behavior-based security system) of the computing device to better identify and respond to various conditions or behaviors that may have a negative impact on its performance, power utilization levels, network usage levels, security and/or privacy over time.

### BACKGROUND

Cellular and wireless communication technologies have seen explosive growth over the past several years. Wireless service providers now offer a wide array of features and services that provide their users with unprecedented levels of access to information, resources and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications on their devices. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, mobile device users frequently use their devices to purchase goods, send and receive sensitive communications, pay bills, manage bank accounts, and conduct other sensitive transactions. Due to these trends, mobile devices are quickly becoming the next frontier for malware and cyber attacks. Accordingly, new and improved security solutions that better protect resource-constrained computing devices, such as mobile and wireless devices, will be beneficial to consumers.

### SUMMARY

The various aspects include methods of generating behavior classifier models for use in a behavior monitoring system of a computing device. Various aspect methods may include applying a plurality of behavior vectors that each characterize one of a known normal and a known abnormal behavior to a current classifier model to generate first analysis results, using the first analysis results to determine confidence values for classifying each of the plurality of behavior vectors as one of normal and abnormal, filtering behavior vectors having confidence values that are above a confidence threshold, generating a new classifier model that includes decision nodes that test conditions relevant to the filtered behavior vectors, setting the new classifier model as the current classifier model, and using the current classifier model in the behavior monitoring system to classify a computing device behavior.

In various aspects, the methods may include, prior to using the current classifier model to classify a behavior, iteratively performing operations of applying the plurality of behavior vectors to the current classifier model to generate the first analysis results, using the first analysis results to determine confidence values for classifying each of the plurality of behavior vectors as one of normal and abnormal, filtering behavior vectors having confidence values that are above a confidence threshold, generating a new classifier model that includes decision nodes that test conditions relevant to the filtered behavior vectors, and setting the new classifier model as the current classifier model until an accuracy of behavior classifications by the behavior monitoring system using the current classifier model exceeds a classifier accuracy threshold.

In a further aspect, the methods may include, prior to filtering behavior vectors, performing refinement operations that include identifying incorrectly classified behavior vectors, determining an adjusted weight value by increasing a weight value associated with the incorrectly classified behavior vectors, generating a new classifier model based on the plurality of behavior vectors and the adjusted weight value.

In further aspects, the methods may include iteratively performing the refinement operations to repeatedly regenerate the new classifier model until a classifier accuracy value associated with the new classifier model exceeds a threshold value. In some aspects, using the current classifier model in the behavior monitoring system to classify a computing device behavior may include monitoring activities of a software application to collect behavior information, generating a behavior vector based on the collected behavior information, applying the generated behavior vector to the current classifier model to generate analysis information, and using the analysis information to classify the behavior as benign or non-benign. In some aspects, using the current classifier model in the behavior monitoring system to classify a computing device behavior may include classifying the computing device behavior as normal or abnormal.

In further aspects, the methods may include sending the current classifier model to a mobile computing device. In some aspects, using the current classifier model in the behavior monitoring system to classify the computing device behavior may include receiving the current classifier model in a mobile computing device, and using the received current classifier model in a behavior monitoring system of the mobile computing device to classify the computing device behavior. In some aspects, using the received current classifier model in a behavior monitoring system of the mobile computing device to classify the computing device behavior may include identifying mobile device features used by a software application operating on the mobile computing device, identifying decision nodes in the received classifier model that evaluate the identified mobile device features, generating a local classifier model in the mobile device that includes and prioritizes the identified decision nodes, and using the locally generated classifier model to classify the computing device behavior.

Further aspects include a computing device that includes means for performing functions of the aspect methods described above. Further aspects include a computing device that includes a processor configured with processor-executable instructions to perform operations of the aspect methods described above. Further aspects include a non-transitory computer readable storage medium having stored thereon processor-executable software instructions configured to cause a processor of a computing device to perform operations of the aspect methods described above.

### BRIEF DESCRIPTION OF THE DRAWINGS

The accompanying drawings, which are incorporated herein and constitute part of this specification, illustrate exemplary aspects of the claims, and together with the general description given above and the detailed description given below, serve to explain the features of the claims.

FIG. 1A is a communication system block diagram illustrating network components of an example telecommunication system that is suitable for use with the various aspects.

FIG. 1B is an architectural diagram of an example system on chip suitable for implementing the various aspects.

FIG. 2 is a block diagram illustrating example logical components and information flows in an aspect mobile device configured to determine whether a particular mobile device behavior is benign or non-benign.

FIG. 3 is a block diagram illustrating example components and information flows in an aspect system that includes a network server configured to work in conjunction with a mobile device to determine whether a particular mobile device behavior is benign or non-benign.

FIGS. 4 through 6 are process flow diagrams illustrating methods of expectation-maximization (EM) machine learning techniques to generate classifier models in accordance with various aspects.

FIG. 7 is a process flow diagram illustrating another aspect mobile device method of generating an application-based or lean classifier models in the mobile device.

FIG. 8 is an illustration of example boosted decision stumps that may be generated by a server processor and used by a device processor to generate lean classifier models according to various aspects.

FIG. 9 is a block diagram illustrating example logical components and information flows in an observer module configured to perform dynamic and adaptive observations in accordance with an aspect.

FIG. 10 is a block diagram illustrating logical components and information flows in a computing system implementing observer daemons in accordance with another aspect.

FIG. 11 is a process flow diagram illustrating an aspect method for performing adaptive observations on mobile devices.

FIG. 12 is a component block diagram of a mobile device suitable for use in various aspects.

FIG. 13 is a component block diagram of a server device suitable for use in various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various aspects include methods, and computing devices configured to implement the methods, of using expectation-maximization (EM) machine learning techniques to continuously, repeatedly, iteratively, or recursively generate, train, improve, focus, or refine machine learning classifier models that are used by a behavior-based monitoring and analysis system (or behavior-based security system) of the computing device to identify and respond to conditions or behaviors that may have a negative impact on the performance, power utilization levels, network usage levels, security and/or privacy of the computing device. The computing device may be configured to train a first classifier model using a conventional technique, use the first classifier model in a behavior-based security system to classify behavior vectors as benign or non-benign with a confidence value (e.g., a confidence number, etc.), increase a weight value associated with incorrectly classified behavior vectors, filter behavior vectors that are classified as non-benign using a confidence threshold, train a new classifier model using the filtered behavior vectors, set the new classifier model as the current classifier model used in the behavior-based security system, and repeat the above-mentioned operations until the resulting classifier model provides a desired level of accuracy in behavior classification.

In some aspects, the computing device may be configured to select a classifier model for use in a behavior-based security system, set the selected classifier model as the current classifier model for the behavior-based security system, apply behavior vectors that each characterize a known-normal or known-abnormal behavior to the current classifier model to generate analysis results, use the analysis results to determine confidence values for classifying each of the behavior vectors as benign or non-benign (or as normal or abnormal), perform refinement operations, filter the behavior vectors (e.g., by selecting the behavior vectors that have a confidence value that is above a confidence threshold, etc.), generate a new classifier model based on the filtered behavior vectors (e.g., generating a classifier model that includes decision nodes that test conditions relevant to the filtered behavior vectors, etc.) and set the new classifier model as the current classifier model used in the behavior-based security system.

In some aspects, the computing device may be further configured to perform refinement operations that include identifying incorrectly classified (or misclassified) behavior vectors, increasing a weight value associated with the incorrectly classified behavior vectors, and generating/selecting a new classifier model based on the behavior vectors with adjusted weights. Alternatively or in addition, after increasing weight values associated with the incorrectly classified behavior vectors, the computing device may reapply the incorrectly classified behavior vectors to the current classifier model to generate new/improved analysis results, and using the new/improved analysis results to determine new confidence values for classifying the behavior vectors as one of normal and abnormal (or benign and non-benign, etc.). In an aspect, the computing device may be configured to perform these refinement operations iteratively or repeatedly until the number of incorrectly classified behavior vectors exceeds (e.g., is greater than, less than, equal to, less than or equal to, etc.) a classification accuracy threshold.

The aspect methods may be implemented in a server that provides results to client computing devices or within computing devices implementing the behavior-based security system. In some aspects the computing device may be configured to perform any or all of the above-mentioned operations (e.g., apply the behavior vectors the new “current” classifier model, determine confidence values, filter the behavior vectors, generate another new classifier model, etc.) until an accuracy associated with the current classifier model exceeds (e.g., is greater than, less than, equal to, greater than or equal to, etc.) a classifier accuracy threshold value, and in response to determining that the accuracy exceeds a classifier accuracy threshold value, send the current classifier model to a client computing device (e.g., a mobile device) if the computing device is a server or, use the current classifier model to classify a device behavior if the computing device implements the classifier model in a behavior-based security system.

For example, if the classifier accuracy threshold value is set to “0.96,” a server computing device may perform the-above mentioned operations until the accuracy associated with current classifier model is greater than or equal to “0.96,” at which point the server may send the classifier model to a mobile device for use in classifying a device behavior using a behavior-based security system. The computing device (e.g., mobile device, etc.) may use the classifier model in the behavior-based security system to classify a behavior, which may include monitoring the activities of a software application to collect behavior information, generating a behavior vector information structure based on the collected behavior information, applying the generated behavior vector information structure to the current classifier model to generate analysis information, and using the analysis information to classify the behavior as benign or non-benign.

By using EM and machine learning techniques to develop classifier models, the computing device may repeatedly or continuously refine and otherwise improve the classifier models until the models reach a desired level of accuracy. This improves the functionality of the behavior-based monitoring and analysis system (or behavior-based security system) and the computing devices by allowing the system to better identify and respond to various conditions or behaviors that may have a negative impact on their security, performance, or power consumption characteristics, and/or which would not otherwise be detected by conventional security solutions. This also improves the functioning of computing devices by allowing them to perform behavior-based analysis operations to identify and respond to non-benign device behaviors without having a significant negative or user-perceivable impact on their responsiveness, performance, or power consumption characteristics. As a result, the various aspects are well suited for inclusion and use in mobile devices and other resource constrained-computing devices, such as smartphones, which have limited resources, run on battery power, and for which performance and security are important.

Additional improvements to the functions, functionalities, and/or functioning of computing devices will be evident from the detailed descriptions of the aspect provided below.

The term “performance degradation” is used in this application to refer to a wide variety of undesirable operations and characteristics of a computing device, such as longer processing times, slower real time responsiveness, lower battery life, loss of private data, malicious economic activity (e.g., sending unauthorized premium SMS message), denial of service (DoS), poorly written or designed software applications, malicious software, malware, viruses, fragmented memory, operations relating to commandeering the mobile device or utilizing the phone for spying or botnet activities, etc. Also, behaviors, activities, and conditions that degrade performance for any of these reasons are referred to herein as “not benign” or “non-benign.”

The terms “computing device” and “mobile device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices which include a memory, and a programmable processor for which performance is important. While the various aspects are particularly useful for mobile computing devices, such as smartphones, which have limited resources and run on battery, the aspects are generally useful in any electronic device that includes a processor and executes application programs.

Many modern computing are resource constrained systems that have limited processing, memory, and energy resources. For example, a mobile device is a complex and resource-constrained computing device that includes many features or factors that could contribute to its degradation in performance and power utilization levels over time. Examples of factors that may contribute to this performance degradation include poorly designed software applications, malware, viruses, fragmented memory, and background processes. Due to the number, variety, and complexity of these factors, it is often not feasible to evaluate all of the various components, behaviors, processes, operations, conditions, states, or features (or combinations thereof) that may degrade performance and/or power utilization levels of these complex yet resource-constrained systems. As such, it is difficult for users, operating systems, or application programs (e.g., anti-virus software, etc.) to accurately and efficiently identify the sources of such problems. As a result, users of mobile and other resource-constrained computing devices currently have few remedies for preventing the degradation in performance and power utilization levels of their devices over time, or for restoring an aging device to its original performance and power utilization levels.

To overcome the limitations of conventional solutions, computing devices may be equipped with a behavioral-based monitoring and analysis system (or behavior-based security system) that is configured to perform real-time behavior monitoring and analysis operations. The behavioral-based monitoring and analysis system may include an observer process, daemon, module, or sub-system (herein collectively referred to as a “module”), a behavior extractor module, an analyzer module, and actuator module. The observer module may be configured to instrument or coordinate various application programming interfaces (APIs), registers, counters, or other device components (herein collectively “instrumented components”) at various levels of the computing device system (e.g., at the hardware, driver, kernel, NDK, SDK, and/or Webkit levels, etc.), collect behavior information from the instrumented components, and communicate (e.g., via a memory write operation, function call, etc.) the collected behavior information to the behavior extractor module.

The behavior extractor module may use the collected behavior information to generate behavior vectors information structures (herein “behavior vectors”) that each represent or characterize many or all of the observed behaviors associated with a specific software application, module, component, task, or process of the computing device. The behavior extractor module may communicate (e.g., via a memory write operation, function call, etc.) the behavior vectors to the analyzer module, which may apply the behavior vectors to machine learning classifier models (herein “classifier models”) to generate analysis results that may be used to classify each behavior vector (e.g., as one of benign, suspicious and non-benign, or as one of normal, suspicious and anomaly, etc.) and determine whether a software application or device behavior characterized by one or more of the vectors is benign or non-benign. The analyzer module may notify the actuator module when it determines with a high degree of confidence (e.g., based on the analysis results, etc.) that a behavior vector, behavior or software application is non-benign. In response, the actuator module may perform various operations to heal, cure, isolate, or otherwise fix the identified problem(s). For example, the actuator module may be configured to quarantine a software application that is determined to be malware, terminate a malicious process, display a prompt to notify the user that a software application is contributing to the device's performance degradation over time, etc.

Each behavior vector may encapsulate, include, or represent one or more “behavior features.” Each behavior feature may represent an observed activity/behavior or an aspect of the device's behavior, such as “Location,” “Personal Identifiers,” “International Mobile Station Equipment Identity (IMEI),” “Communications,” and “Short Message Service (SMS).” Each behavior feature may include a feature value, which may be an abstract number or symbol that represents all or a portion of the observed activity/behavior. Each behavior feature may also be associated with a data type that identifies a range of possible values (e.g., a range for the feature value), operations that may be performed on those values, meanings of the values, etc. The data type may be used by the computing device to determine how the behavior feature (or its feature value) should be measured, analyzed, weighted, or used.

In addition, each behavior feature in a behavior vector may be mapped to one or more APIs. As an example, the behavior feature “User Interaction” may include the feature value “amount,” which may be an integer (or a floating point value, double, etc.) that is incremented each time one of the View.onTouchEvent( ), View.onKeyDown, View.onKeyUp, or View.onTrackBallEvent APIs is called or invoked. In other words, the “User Interaction” behavior feature may describe the frequency in which the user interacts with the computing device via its feature value “amount.” To accomplish this, the “User Interaction” behavior feature and/or its feature value is mapped to multiple APIs, including the View.onTouchEvent( ), View.onKeyDown, View.onKeyUp, and View.onTrackBallEvent APIs. Further, since the feature value “amount” is incremented each time any of the mapped APIs is invoked, there is a one-to-one mapping of the behavior feature to each API. Said another way, the behavior feature “User Interaction” includes one-to-one API-to-feature mapping.

As mentioned above, behavior vectors may be applied to classifier models in a behavior-based security system to generate the analysis results that are suitable for use in classifying device behaviors. A classifier model may be a behavior model that includes data and/or information structures (e.g., decision nodes, component lists, etc.) that may be used by the computing device processor to evaluate a specific behavior feature or an aspect of the device's observed behavior. A classifier model may also include decision nodes and/or decision criteria for monitoring or analyzing a number of features, factors, data points, entries, APIs, states, conditions, behaviors, software applications, processes, operations, components, etc. (herein collectively “features”) in the computing device.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes or prioritizes tests on the features/entries that are most relevant for determining whether a particular behavior vector (or device behavior, etc.) is benign or non-benign. A locally generated lean classifier model may be a lean classifier model that is generated in the computing device in which it is used.

Each classifier model may include multiple decision nodes (e.g., decision trees, boosted decision stumps, etc.), and each decision node may include a weight value and a test question/condition that is suitable for evaluating a behavior feature. For example, a classifier model may include a decision node (e.g., in the form of decision stump, etc.) that evaluates the condition “is the frequency of SMS communications of location-based information less than X per minute.” In this example, applying behavior vector that includes an “SMS” behavior feature having a feature value of “3” to the classifier model may generate a result that indicates a “yes” answer (for “less than X” SMS transmissions) or a “no” answer (for “X or more” SMS transmissions) via a symbol or a number, such as “1” for “yes” and “0” for “no”.

Since each classifier model may include multiple decision nodes and each behavior vector may include multiple behavior features, applying a behavior vector to a classifier model may generate a plurality of answers to a plurality of different test conditions. Each of these answers may be represented by a numerical value. The computing device may multiply each of these numerical values with their respective weight value to generate a plurality of weighted answers. The computing device may then compute or determine a weighted average based on the weighted answers, and compare the computed weighted average to threshold values, such as an upper threshold and a lower threshold.

The computing device may use the result of these comparisons to determine whether the activities characterized by the behavior vector may be classified as benign or non-benign with a high degree of confidence. For example, if the computed weighted average is “0.95” and an upper threshold value for non-benign applications is “0.80,” the computing device may classify the behavior characterized by the behavior vector as “non-benign” with a high degree of confidence because the computed weighted average exceeds the upper/high threshold value (i.e., “0.95”>“0.80”). Similarly, if the computed weighted average is “0.10” and the lower/low threshold value for non-benign applications is “0.20,” the computing device may classify the behavior vector (and thus the observed behavior) as “benign” with a high degree of confidence because the computed weighted average exceeds the lower or low threshold value (i.e., “0.10”<“0.20”).

The computing device may be configured to determine that a behavior (or behavior vector) is “suspicious” when it cannot classify a behavior with a sufficiently high degree of confidence as being either “benign” or “non-benign,” such as when the value of the computed weighted average is below the high threshold and above the low threshold value. For example, the computing device may determine that a behavior (or behavior vector) is “suspicious” when the computed weighted average is 0.50, the upper threshold value is 0.95, lower threshold value is 0.20. In response to determining that the behavior is suspicious, the computing device may select a stronger (e.g., less lean, more focused, etc.) classifier model and repeat any or all of the above-described operations to generate additional or different analysis results. The computing device may use this new or additional analysis information to determine whether the suspicious behavior (e.g., the behavior vector and/or the activities characterized by the vector) may be classified as either benign or non-benign with a high degree of confidence. If not, the computing device may repeatedly or continuously perform the-above described operations until it determines that the behavior (or behavior vector) can be classified as benign or non-benign with a high degree of confidence (e.g., until the weighted average is above the high threshold or below the low threshold, etc.), until a processing or battery consumption threshold is reached, or until the computing device determines that the cause or source of the suspicious behavior cannot be identified from the use of stronger classifier models, larger behavior vectors, or changes in observation granularity.

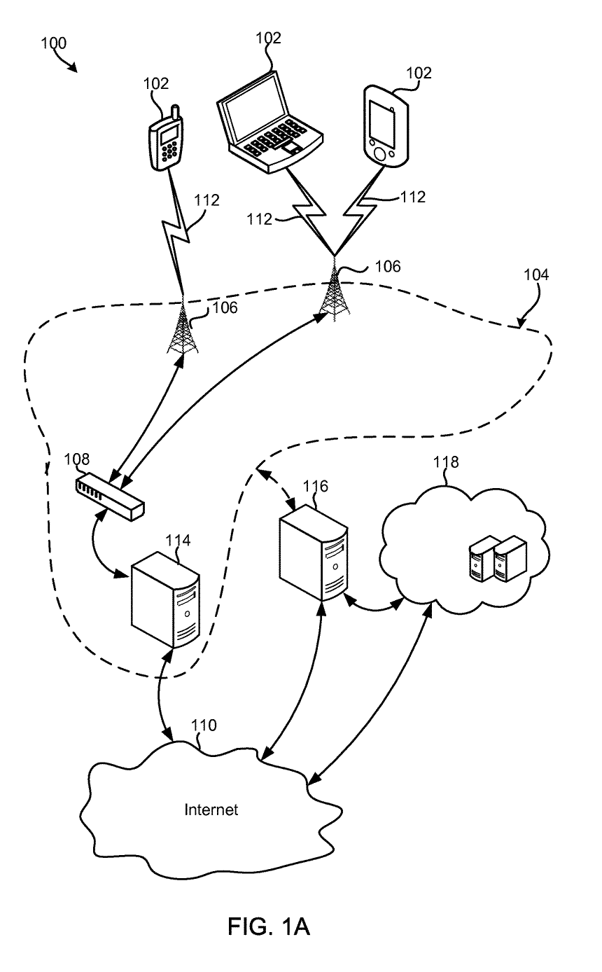

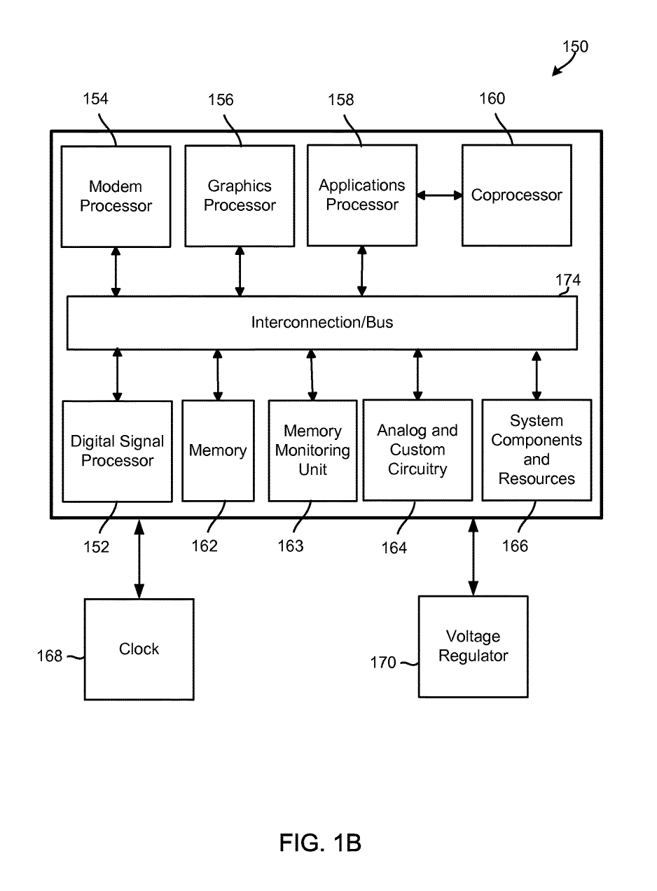

The various aspects may be implemented within a variety of communication systems, such as the example communication system 100 illustrated in FIG. 1A. A typical cell telephone network 104 includes a plurality of cell base stations 106 coupled to a network operations center 108, which operates to connect voice calls and data between mobile devices 102 (e.g., cell phones, laptops, tablets, etc.) and other network destinations, such as via telephone land lines (e.g., a POTS network, not shown) and the Internet 110. Communications between the mobile devices 102 and the telephone network 104 may be accomplished via two-way wireless communication links 112, such as 4G, 3G, CDMA, TDMA, LTE and/or other cell telephone communication technologies. The telephone network 104 may also include one or more servers 114 coupled to or within the network operations center 108 that provide a connection to the Internet 110.

The communication system 100 may further include network servers 116 connected to the telephone network 104 and to the Internet 110. The connection between the network servers 116 and the telephone network 104 may be through the Internet 110 or through a private network (as illustrated by the dashed arrows). A network server 116 may also be implemented as a server within the network infrastructure of a cloud service provider network 118. Communication between the network server 116 and the mobile devices 102 may be achieved through the telephone network 104, the internet 110, private network (not illustrated), or any combination thereof.

The network server 116 may be configured to receive information on various conditions, features, behaviors, and corrective actions from a central database or cloud service provider network 118, and use this information to generate data, algorithms, classifiers, or behavior models (herein collectively “classifier models”) that include data and/or information structures (e.g., feature vectors, behavior vectors, component lists, etc.) that may be used by a processor of a computing device to evaluate a specific aspect of the computing device's behavior.

In an aspect, the network server 116 may be configured to generate a full classifier model. The full classifier model may be a robust data model that is generated as a function of a large training dataset, which may include thousands of features and billions of entries. In an aspect, the network server 116 may be configured to generate the full classifier model to include all or most of the features, data points, and/or factors that could contribute to the degradation of any of a number of different makes, models, and configurations of mobile devices 102. In various aspects, the network server may be configured to generate the full classifier model to describe or express a large corpus of behavior information as a finite state machine, decision nodes, decision trees, or in any information structure that can be modified, culled, augmented, or otherwise used to quickly and efficiently generate leaner classifier models.

In addition, the mobile device 102 may be configured to receive the full classifier model from the network server 116. The mobile device may be further configured to use the full classifier model to generate more focused classifier models that account for the specific features and functionalities of the software applications of the mobile device 102. For example, the mobile device 102 may generate application-specific and/or application-type-specific classifier models (i.e., data or behavior models) that preferentially or exclusively identify or evaluate the conditions or features of the mobile device that are relevant to a specific software application or to a specific type of software application (e.g., games, navigation, financial, etc.) that is installed on the mobile device 102 or stored in a memory of the device. The mobile device 102 may use these locally generated classifier models to perform real-time behavior monitoring and analysis operations.

The various aspects may be implemented in a number of different computing devices, including single processor and multiprocessor systems, and a system-on-chip (SOC). FIG. 1B is an architectural diagram illustrating an example system-on-chip (SOC) 150 architecture that may be used in computing devices implementing the various aspects. The SOC 150 may include a number of heterogeneous processors, such as a digital signal processor (DSP) 152, a modem processor 154, a graphics processor 156, and an application processor 158. The SOC 150 may also include one or more coprocessors 160 (e.g., vector co-processor) connected to one or more of the heterogeneous processors 152, 154, 156, 158. Each processor 152, 154, 156, 158, 160 may include one or more cores, and each processor/core may perform operations independent of the other processors/cores. For example, the SOC 150 may include a processor that executes a first type of operating system (e.g., FreeBSD, LINIX, OS X, etc.) and a processor that executes a second type of operating system (e.g., Microsoft Windows 8).

The SOC 150 may also include analog circuitry and custom circuitry 164 for managing sensor data, analog-to-digital conversions, wireless data transmissions, and for performing other specialized operations, such as processing encoded audio signals for games and movies. The SOC 150 may further include system components and resources 166, such as voltage regulators, oscillators, phase-locked loops, peripheral bridges, data controllers, memory controllers, system controllers, access ports, timers, and other similar components used to support the processors and clients running on a computing device.

The system components/resources 166 and custom circuitry 164 may include circuitry to interface with peripheral devices, such as cameras, electronic displays, wireless communication devices, external memory chips, etc. The processors 152, 154, 156, 158 may be interconnected to one or more memory elements 162, system components, and resources 166 and custom circuitry 164 via an interconnection/bus module 174, which may include an array of reconfigurable logic gates and/or implement a bus architecture (e.g., CoreConnect, AMBA, etc.). Communications may be provided by advanced interconnects, such as high performance networks-on chip (NoCs).

An operating system executing in one or more of the processors 152, 154, 156, 158, 160 may be configured to control and coordinate the allocation and use of memory by the software applications, and partition the physical memory across the multiple software applications. As such, the operating system may include one or more memory management systems or processes (e.g., a virtual memory manager, etc.) that manage the allocation and use of memory by the various software applications, and ensure that the memory used by one process does not interfere with memory already in use by another process.

In addition to the software-based memory management systems or processes (e.g., OS VMM, etc.) discussed above, the SOC 150 may include one or more hardware-based memory management systems, such as a central processing unit (CPU) memory management unit (MMU) and a system MMU. The CPU MMU and the system MMU may be hardware components that are responsible for performing various memory related operations, such as the translation of virtual addresses to physical addresses, cache control, bus arbitration, and memory protection. For example, the CPU MMU may be responsible for providing address translation services and protection functionalities to the main CPU (e.g., the application processor 108), and the system MMU may be responsible for providing address translation services and protection functionalities to other hardware components (e.g., digital signal processor 152, modem processor 154, a graphics processor 156, etc.).

The SOC 150 may also include a hardware-based memory monitoring unit 163, which may be a programmable logic circuit (PLC) that is configured to monitor the access or use of the MMUs and memory elements 162 by software applications at the hardware level and/or based on hardware events (e.g., memory read and write operations, etc.). The hardware-based memory monitoring unit 163 may be separate from, and operate independent of, the other hardware and software-based memory management systems and MMUs of the device.

In various aspects, the hardware-based memory monitoring unit 163 may be configured to monitor the access and use of the MMUs and memory elements 152 by the software applications to collect memory usage information, and compare the collected memory usage information to memory usage patterns (which may be programmed into the PLC) to identify relationships between applications and/or to determine whether the use of memory by the software applications is indicative of a suspicious or colluding behavior. The hardware-based memory monitoring unit 163 may then report the identified relationships and/or suspicious or colluding behaviors to the observer or analyzer modules (e.g., via the processors 152, 154, 156, 158).

The SOC 150 may further include an input/output module (not illustrated) for communicating with resources external to the SOC, such as a clock 168 and a voltage regulator 170. Resources external to the SOC (e.g., clock 168, voltage regulator 170) may be shared by two or more of the internal SOC processors/cores (e.g., DSP 152, modem processor 154, etc.).

The SOC 150 may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components (e.g., accelerometer, etc.) of modern electronic devices.

In addition to the SOC 150 discussed above, the various aspects may be implemented in a wide variety of computing systems, which may include a single processor, multiple processors, multicore processors, or any combination thereof. In an aspect, the SOC 150 may be included in a mobile computing device 102.

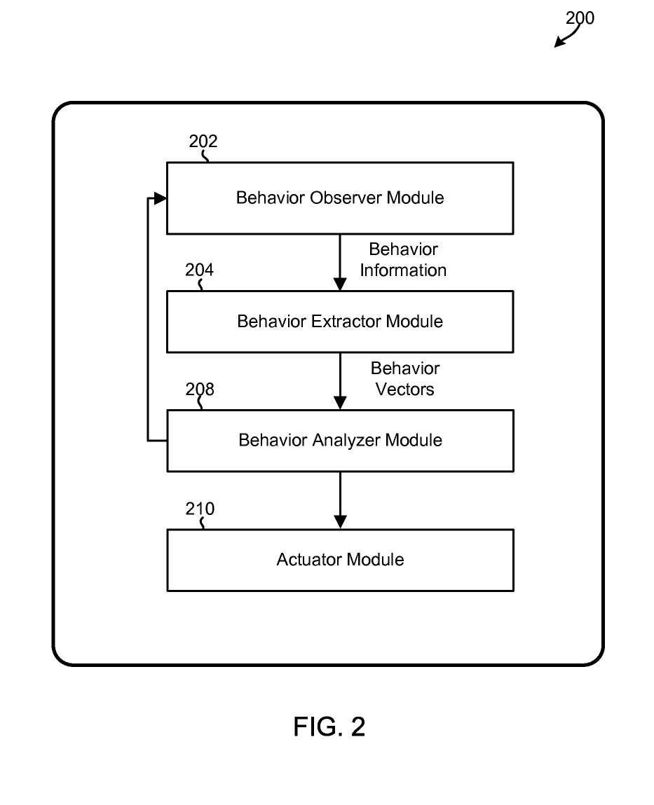

FIG. 2 illustrates example logical components and information flows in an aspect computing device that includes a behavior-based monitoring and analysis system 200 configured to use behavioral analysis techniques to identify and respond to non-benign device behaviors. The computing device may include a device processor (i.e., mobile device processor) configured with executable instruction modules that include a behavior observer module 202, a behavior extractor module 204, a behavior analyzer module 208, and an actuator module 210. Each of the modules 202-210 may be a thread, process, daemon, module, sub-system, or component that is implemented in software, hardware, or a combination thereof. In various aspects, the modules 202-210 may be implemented within parts of the operating system (e.g., within the kernel, in the kernel space, in the user space, etc.), within separate programs or applications, in specialized hardware buffers or processors, or any combination thereof. In an aspect, one or more of the modules 202-210 may be implemented as software instructions executing on one or more processors of the computing device.

The behavior observer module 202 may be configured to instrument application programming interfaces (APIs), counters, hardware monitors, etc. at various levels/modules of the device, and monitor the activities, conditions, operations, and events (e.g., system events, state changes, etc.) at the various levels/modules over a period of time. For example, the behavior observer module 202 may be configured to monitor various software and hardware components of the computing device, and collect behavior information pertaining to the interactions, communications, transactions, events, or operations of the monitored and measurable components that are associated with the activities of the computing device. Such activities include a software application's use of a hardware component, performance of an operation or task, a software application's execution in a processing core of the computing device, the execution of process, the performance of a task or operation, a device behavior, etc.

As a further example, the behavior observer module 202 may be configured to monitor the activities of the computing device by monitoring the allocation or use of device memory by the software applications. In an aspect, this may be accomplished by monitoring the operations of memory management system (e.g., a virtual memory manager, memory management unit, etc.) of the computing device. Such systems are generally responsible for managing the allocation and use of system memory by the various application programs to ensure that the memory used by one process does not interfere with memory already in use by another process. Therefore, by monitoring the operations of the memory management system, the device processor may collect behavior information that is suitable for use in determining whether to two applications are working in concert, such as whether two processes have been allocated the same memory space, are reading and writing information to the same memory address or location, or are performing other suspicious memory-related operations.

The behavior observer module 202 may collect behavior information pertaining to the monitored activities, conditions, operations, or events, and store the collected information in a memory (e.g., in a log file, etc.). The behavior observer module 202 may then communicate (e.g., via a memory write operation, function call, etc.) the collected behavior information to the behavior extractor module 204.

In an aspect, the behavior observer module 202 may be configured to monitor the activities of the computing device by monitoring the allocation or use of device memory at the hardware level and/or based on hardware events (e.g., memory read and write operations, etc.). In a further aspect, the behavior observer module 202 may be implemented in a hardware module (e.g., the memory monitoring unit 113 described above with reference to FIG. 1) for faster, near-real time execution of the monitoring functions. For example, the behavior observer module 202 may be implemented within a hardware module that includes a programmable logic circuit (PLC) in which the programmable logic elements are configured to monitor the allocation or use of computing device memory at the hardware level and/or based on hardware events (e.g., memory read and write operations, etc.) and otherwise implement the various aspects. Such a hardware module may output results of hardware event monitoring to the device processor implementing the behavior extractor module 204. A PLC may be configured to monitor certain hardware and implement certain operations of the various aspects described herein using PLC programming methods that are well known. Other circuits for implementing some operation of the aspect methods in a hardware module may also be used.

Similarly, each of the modules 202-210 may be implemented in hardware modules, such as by including one or PLC elements in an SoC with the PLC element(s) configured using PLC programming methods to perform some operation of the aspect methods.

The behavior extractor module 204 may be configured to receive or retrieve the collected behavior information, and use this information to generate one or more behavior vectors. In the various aspects, the behavior extractor module 204 may be configured to generate the behavior vectors to include a concise definition of the observed behaviors, relationships, or interactions of the software applications. For example, each behavior vector may succinctly describe the collective behavior of the software applications in a value or vector data-structure. The vector data-structure may include series of numbers, each of which signifies a feature or a behavior of the device, such as whether a camera of the computing device is in use (e.g., as zero or one), how much network traffic has been transmitted from or generated by the computing device (e.g., 20 KB/sec, etc.), how many interne messages have been communicated (e.g., number of SMS messages, etc.), and/or any other behavior information collected by the behavior observer module 202. In an aspect, the behavior extractor module 204 may be configured to generate the behavior vectors so that they function as an identifier that enables the computing device system (e.g., the behavior analyzer module 208) to quickly recognize, identify, or analyze the relationships between applications.

The behavior analyzer module 208 may be configured to apply the behavior vectors to classifier modules to identify the nature of the relationship between two or more software applications. The behavior analyzer module 208 may also be configured to apply the behavior vectors to classifier modules to determine whether a collective device behavior (i.e., the collective activities of two or more software applications operating on the device) is a non-benign behavior that is contributing to (or is likely to contribute to) the device's degradation over time and/or which may otherwise cause problems on the device.

The behavior analyzer module 208 may notify the actuator module 210 that an activity or behavior is not benign. In response, the actuator module 210 may perform various actions or operations to heal, cure, isolate, or otherwise fix identified problems. For example, the actuator module 210 may be configured to stop or terminate one or more of the software applications when the result of applying the behavior vector to the classifier model (e.g., by the analyzer module) indicates that the collective behavior of the software applications not benign.

In various aspects, the behavior observer module 202 may be configured to monitor the activities of the computing device by collecting information pertaining to library API calls in an application framework or run-time libraries, system call APIs, file-system and networking sub-system operations, device (including sensor devices) state changes, and other similar events. In addition, the behavior observer module 202 may monitor file system activity, which may include searching for filenames, categories of file accesses (personal info or normal data files), creating or deleting files (e.g., type exe, zip, etc.), file read/write/seek operations, changing file permissions, etc.

The behavior observer module 202 may also monitor the activities of the computing device by monitoring data network activity, which may include types of connections, protocols, port numbers, server/client that the device is connected to, the number of connections, volume or frequency of communications, etc. The behavior observer module 202 may monitor phone network activity, which may include monitoring the type and number of calls or messages (e.g., SMS, etc.) sent out, received, or intercepted (e.g., the number of premium calls placed).

The behavior observer module 202 may also monitor the activities of the computing device by monitoring the system resource usage, which may include monitoring the number of forks, memory access operations, number of files open, etc. The behavior observer module 202 may monitor the state of the computing device, which may include monitoring various factors, such as whether the display is on or off, whether the device is locked or unlocked, the amount of battery remaining, the state of the camera, etc. The behavior observer module 202 may also monitor inter-process communications (IPC) by, for example, monitoring intents to crucial services (browser, contracts provider, etc.), the degree of inter-process communications, pop-up windows, etc.

The behavior observer module 202 may also monitor the activities of the computing device by monitoring driver statistics and/or the status of one or more hardware components, which may include cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the computing device.

The behavior observer module 202 may also monitor the activities of the computing device by monitoring one or more hardware counters that denote the state or status of the computing device and/or computing device sub-systems. A hardware counter may include a special-purpose register of the processors/cores that is configured to store a count value or state of hardware-related activities or events occurring in the computing device.

The behavior observer module 202 may also monitor the activities of the computing device by monitoring the actions or operations of software applications, software downloads from an application download server (e.g., Apple® App Store server), computing device information used by software applications, call information, text messaging information (e.g., SendSMS, BlockSMS, ReadSMS, etc.), media messaging information (e.g., ReceiveMMS), user account information, location information, camera information, accelerometer information, browser information, content of browser-based communications, content of voice-based communications, short range radio communications (e.g., Bluetooth, WiFi, etc.), content of text-based communications, content of recorded audio files, phonebook or contact information, contacts lists, etc.

The behavior observer module 202 may also monitor the activities of the computing device by monitoring transmissions or communications of the computing device, including communications that include voicemail (VoiceMailComm), device identifiers (DeviceIDComm), user account information (UserAccountComm), calendar information (CalendarComm), location information (LocationComm), recorded audio information (RecordAudioComm), accelerometer information (AccelerometerComm), etc.

The behavior observer module 202 may also monitor the activities of the computing device by monitoring the usage of, and updates/changes to, compass information, computing device settings, battery life, gyroscope information, pressure sensors, magnet sensors, screen activity, etc. The behavior observer module 202 may monitor notifications communicated to and from a software application (AppNotifications), application updates, etc. The behavior observer module 202 may monitor conditions or events pertaining to a first software application requesting the downloading and/or install of a second software application. The behavior observer module 202 may monitor conditions or events pertaining to user verification, such as the entry of a password, etc.

The behavior observer module 202 may also monitor the activities of the computing device by monitoring conditions or events at multiple levels of the computing device, including the application level, radio level, and sensor level. Application level observations may include observing the user via facial recognition software, observing social streams, observing notes entered by the user, observing events pertaining to the use of PassBook®, Google® Wallet, Paypal®, and other similar applications or services. Application level observations may also include observing events relating to the use of virtual private networks (VPNs) and events pertaining to synchronization, voice searches, voice control (e.g., lock/unlock a phone by saying one word), language translators, the offloading of data for computations, video streaming, camera usage without user activity, microphone usage without user activity, etc.

Radio level observations may include determining the presence, existence or amount of any or more of user interaction with the computing device before establishing radio communication links or transmitting information, dual/multiple subscriber identification module (SIM) cards, Internet radio, mobile phone tethering, offloading data for computations, device state communications, the use as a game controller or home controller, vehicle communications, computing device synchronization, etc. Radio level observations may also include monitoring the use of radios (WiFi, WiMax, Bluetooth, etc.) for positioning, peer-to-peer (p2p) communications, synchronization, vehicle to vehicle communications, and/or machine-to-machine (m2m). Radio level observations may further include monitoring network traffic usage, statistics, or profiles.

Sensor level observations may include monitoring a magnet sensor or other sensor to determine the usage and/or external environment of the computing device. For example, the computing device processor may be configured to determine whether the device is in a holster (e.g., via a magnet sensor configured to sense a magnet within the holster) or in the user's pocket (e.g., via the amount of light detected by a camera or light sensor). Detecting that the computing device is in a holster may be relevant to recognizing suspicious behaviors, for example, because activities and functions related to active usage by a user (e.g., taking photographs or videos, sending messages, conducting a voice call, recording sounds, etc.) occurring while the computing device is holstered could be signs of nefarious processes executing on the device (e.g., to track or spy on the user).

Other examples of sensor level observations related to usage or external environments may include, detecting NFC signaling, collecting information from a credit card scanner, barcode scanner, or mobile tag reader, detecting the presence of a Universal Serial Bus (USB) power charging source, detecting that a keyboard or auxiliary device has been coupled to the computing device, detecting that the computing device has been coupled to another computing device (e.g., via USB, etc.), determining whether an LED, flash, flashlight, or light source has been modified or disabled (e.g., maliciously disabling an emergency signaling app, etc.), detecting that a speaker or microphone has been turned on or powered, detecting a charging or power event, detecting that the computing device is being used as a game controller, etc. Sensor level observations may also include collecting information from medical or healthcare sensors or from scanning the user's body, collecting information from an external sensor plugged into the USB/audio jack, collecting information from a tactile or haptic sensor (e.g., via a vibrator interface, etc.), collecting information pertaining to the thermal state of the computing device, etc.

To reduce the number of factors monitored to a manageable level, in an aspect, the behavior observer module 202 may be configured to perform coarse observations by monitoring/observing an initial set of behaviors or factors that are a small subset of all factors that could contribute to the computing device's degradation. In an aspect, the behavior observer module 202 may receive the initial set of behaviors and/or factors from a server and/or a component in a cloud service or network. In an aspect, the initial set of behaviors/factors may be specified in machine learning classifier models.

Each classifier model may be a behavior model that includes data and/or information structures (e.g., feature vectors, behavior vectors, component lists, etc.) that may be used by a computing device processor to evaluate a specific feature or aspect of a computing device's behavior. Each classifier model may also include decision criteria for monitoring a number of features, factors, data points, entries, APIs, states, conditions, behaviors, applications, processes, operations, components, etc. (herein collectively “features”) in the computing device. The classifier models may be preinstalled on the computing device, downloaded or received from a network server, generated in the computing device, or any combination thereof. The classifier models may be generated by using crowd sourcing solutions, behavior modeling techniques, machine learning algorithms, etc.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes/tests only the features/entries that are most relevant for determining whether a particular activity is an ongoing critical activity and/or whether a particular computing device behavior is not benign. As an example, a device processor may be may be configured to receive a full classifier model from a network server, generate a lean classifier model in the computing device based on the full classifier, and use the locally generated lean classifier model to classify a behavior of the device as being either benign or non-benign (i.e., malicious, performance degrading, etc.).

A locally generated lean classifier model is a lean classifier model that is generated in the computing device. That is, since modern computing devices (e.g., mobile devices, etc.) are highly configurable and complex systems, the features that are most important for determining whether a particular device behavior is non-benign (e.g., malicious or performance-degrading) may be different in each device. Further, a different combination of features may require monitoring and/or analysis in each device in order for that device to quickly and efficiently determine whether a particular behavior is non-benign. Yet, the precise combination of features that require monitoring and analysis, and the relative priority or importance of each feature or feature combination, can often only be determined using information obtained from the specific device in which the behavior is to be monitored or analyzed. For these and other reasons, various aspects may generate classifier models in the computing device in which the models are used. These local classifier models allow the device processor to accurately identify the specific features that are most important in determining whether a behavior on that specific device is non-benign (e.g., contributing to that device's degradation in performance). The local classifier models also allow the device processor to prioritize the features that are tested or evaluated in accordance with their relative importance to classifying a behavior in that specific device.

A device-specific classifier model is a classifier model that includes a focused data model that includes/tests only computing device-specific features/entries that are determined to be most relevant to classifying an activity or behavior in a specific computing device. An application-specific classifier model is a classifier model that includes a focused data model that includes/tests only the features/entries that are most relevant for evaluating a particular software application. By dynamically generating application-specific classifier models locally in the computing device, the various aspects allow the device processor to focus its monitoring and analysis operations on a small number of features that are most important for determining whether the operations of a specific software application are contributing to an undesirable or performance degrading behavior of that device.

A multi-application classifier model may be a local classifier model that includes a focused data model that includes or prioritizes tests on the features/entries that are most relevant for determining whether the collective behavior of two or more specific software applications (or specific types of software applications) is non-benign. A multi-application classifier model may include an aggregated feature set and/or decision nodes that test/evaluate an aggregated set of features. The device processor may be configured to generate a multi-application classifier model by identifying the device features that are most relevant for identifying the relationships, interactions, and/or communications between two or more software applications operating on the computing device, identifying the test conditions that evaluate one of identified device features, determining the priority, importance, or success rates of the identified test conditions, prioritizing or ordering the identified test conditions in accordance with their importance or success rates, and generating the classifier model to include the identified test conditions so that they are ordered in accordance with their determined priorities, importance, or success rates. The device processor may also be configured to generate a multi-application classifier model by combining two or more application-specific classifier models.

In various aspects, the device processor may be configured to generate a multi-application classifier model in response to determine that two or more applications are colluding or working in concert or that applications should be analyzed together as a group. The device processor may be configured to generate a multi-application classifier model for each identified group or class of applications. However, analyzing every group may consume a significant amount of the device's limited resources. Therefore, in an aspect, the device processor may be configured to determine the probability that an application is engaged in a collusive behavior (e.g., based on its interactions with the other applications, etc.), and intelligently generate the classifier models for only the groups that include software applications for which there is a high probability of collusive behavior.

The behavior analyzer module 208 may be configured to apply the behavior vectors generated by the behavior extractor module 204 to a classifier model to determine whether a monitored activity (or behavior) is benign or non-benign. In an aspect, the behavior analyzer module 208 may classify a behavior as “suspicious” when the results of its behavioral analysis operations do not provide sufficient information to classify the behavior as either benign or non-benign.

The behavior analyzer module 208 may be configured to notify the behavior observer module 202 in response to identifying the colluding software applications, determining that certain applications should be evaluated as a group, and/or in response to determining that a monitored activity or behavior is suspicious. In response, the behavior observer module 202 may adjust the granularity of its observations (i.e., the level of detail at which computing device features are monitored) and/or change the applications/factors/behaviors that are monitored based on information received from the behavior analyzer module 208 (e.g., results of the real-time analysis operations), generate or collect new or additional behavior information, and send the new/additional information to the behavior analyzer module 208 for further analysis/classification.

Such feedback communications between the behavior observer module 202 and the behavior analyzer module 208 enable the computing device to recursively increase the granularity of the observations (i.e., make finer or more detailed observations) or change the features/behaviors that are observed until a collective behavior is classified as benign or non-benign, a source of a suspicious or performance-degrading behavior is identified, until a processing or battery consumption threshold is reached, or until the device processor determines that the source of the suspicious or performance-degrading device behavior cannot be identified from further changes, adjustments, or increases in observation granularity. Such feedback communication also enable the computing device to adjust or modify the behavior vectors and classifier models without consuming an excessive amount of the computing device's processing, memory, or energy resources.

The behavior observer module 202 and the behavior analyzer module 208 may provide, either individually or collectively, real-time behavior analysis of the computing system's behaviors to identify suspicious behavior from limited and coarse observations, to dynamically determine behaviors to observe in greater detail, and to dynamically determine the level of detail required for the observations. This allows the computing device to efficiently identify and prevent problems without requiring a large amount of processor, memory, or battery resources on the device.

In various aspects, the device processor of the computing device may be configured to identify a critical data resource that requires close monitoring, monitor (e.g., via the behavior observer module 202) API calls made by software applications when accessing the critical data resource, identify a pattern of API calls as being indicative of non-benign behavior by two or more software applications, generate a behavior vector based on the identified pattern of API calls and resource usage, use the behavior vector to perform behavior analysis operations (e.g., via the behavior analyzer module 208), and determine whether one or more of the software application is non-benign based on the behavior analysis operations.

In an aspect, the device processor may be configured to identify APIs that are used most frequently by software applications operating on the computing device, store information regarding usage of identified hot APIs in an API log in a memory of the device, and perform behavior analysis operations based on the information stored in the API log to identify a non-benign behavior.

In the various aspects, the computing device may be configured to work in conjunction with a network server to intelligently and efficiently identify the features, factors, and data points that are most relevant to determining whether an activity or behavior is non-benign. For example, the device processor may be configured to receive a full classifier model from the network server, and use the received full classifier model to generate lean classifier models (i.e., data/behavior models) that are specific for the features and functionalities of the computing device or the software applications operating on the device. The device processor may use the full classifier model to generate a family of lean classifier models of varying levels of complexity (or “leanness”). The leanest family of lean classifier models (i.e., the lean classifier model based on the fewest number of test conditions) may be applied routinely until a behavior is encountered that the model cannot categorize as either benign or not benign (and therefore is categorized by the model as suspicious), at which time a more robust (i.e., less lean) lean classifier model may be applied in an attempt to categorize the behavior. The application of ever more robust lean classifier models within the family of generated lean classifier models may be applied until a definitive classification of the behavior is achieved. In this manner, the device processor can strike a balance between efficiency and accuracy by limiting the use of the most complete, but resource-intensive lean classifier models to those situations where a robust classifier model is needed to definitively classify a behavior.

In various aspects, the device processor may be configured to generate lean classifier models by converting a finite state machine representation/expression included in a full classifier model into boosted decision stumps. The device processor may prune or cull the full set of boosted decision stumps based on device-specific features, conditions, or configurations to generate a classifier model that includes a subset of boosted decision stumps included in the full classifier model. The device processor may then use the lean classifier model to intelligently monitor, analyze and/or classify a computing device behavior.

Boosted decision stumps are one level decision trees that have exactly one node (and thus one test question or test condition) and a weight value, and thus are well suited for use in a binary classification of data/behaviors. That is, applying a behavior vector to boosted decision stump results in a binary answer (e.g., Yes or No). For example, if the question/condition tested by a boosted decision stump is “is the frequency of Short Message Service (SMS) transmissions less than x per minute,” applying a value of “3” to the boosted decision stump will result in either a “yes” answer (for “less than 3” SMS transmissions) or a “no” answer (for “3 or more” SMS transmissions).

Boosted decision stumps are efficient because they are very simple and primal (and thus do not require significant processing resources). Boosted decision stumps are also very parallelizable, and thus many stumps may be applied or tested in parallel/at the same time (e.g., by multiple cores or processors in the computing device).

In an aspect, the device processor may be configured to generate a lean classifier model that includes a subset of classifier criteria included in the full classifier model and only those classifier criteria corresponding to the features relevant to the computing device configuration, functionality, and connected/included hardware. The device processor may use this lean classifier model(s) to monitor only those features and functions present or relevant to the device. The device processor may then periodically modify or regenerate the lean classifier model(s) to include or remove various features and corresponding classifier criteria based on the computing device's current state and configuration.

As an example, the device processor may be configured to receive a large boosted-decision-stumps classifier model that includes decision stumps associated with a full feature set of behavior models (e.g., classifiers), and derive one or more lean classifier models from the large classifier models by selecting only features from the large classifier model(s) that are relevant the computing device's current configuration, functionality, operating state and/or connected/included hardware, and including in the lean classifier model a subset of boosted decision stumps that correspond to the selected features. In this aspect, the classifier criteria corresponding to features relevant to the computing device may be those boosted decision stumps included in the large classifier model that test at least one of the selected features. The device processor may then periodically modify or regenerate the boosted decision stumps lean classifier model(s) to include or remove various features based on the computing device's current state and configuration so that the lean classifier model continues to include application-specific or device-specific feature boosted decision stumps.

In addition, the device processor may also dynamically generate application-specific classifier models that identify conditions or features that are relevant to specific software applications (Google® wallet and eTrade®) and/or to a specific type of software application (e.g., games, navigation, financial, news, productivity, etc.). These classifier models may be generated to include a reduced and more focused subset of the decision nodes that are included in the full classifier model (or of those included in a leaner classifier model generated from the received full classifier model). These classifier models may be combined to generate multi-application classifier models.

In various aspects, the device processor may be configured to generate application-based classifier models for each software application in the system and/or for each type of software application in the system. The device processor may also be configured to dynamically identify the software applications and/or application types that are a high risk or susceptible to abuse (e.g., financial applications, point-of-sale applications, biometric sensor applications, etc.), and generate application-based classifier models for only the software applications and/or application types that are identified as being high risk or susceptible to abuse. In various aspects, device processor may be configured to generate the application-based classifier models dynamically, reactively, proactively, and/or every time a new application is installed or updated.

Each software application generally performs a number of tasks or activities on the computing device. The specific execution state in which certain tasks/activities are performed in the computing device may be a strong indicator of whether a behavior or activity merits additional or closer scrutiny, monitoring and/or analysis. As such, in the various aspects, the device processor may be configured to use information identifying the actual execution states in which certain tasks/activities are performed to focus its behavioral monitoring and analysis operations, and better determine whether an activity is a critical activity and/or whether the activity is non-benign.

In various aspects, the device processor may be configured to associate the activities/tasks performed by a software application with the execution states in which those activities/tasks were performed. For example, the device processor may be configured to generate a behavior vector that includes the behavior information collected from monitoring the instrumented components in a sub-vector or data-structure that lists the features, activities, or operations of the software for which the execution state is relevant (e.g., location access, SMS read operations, sensor access, etc.). In an aspect, this sub-vector/data-structure may be stored in association with a shadow feature value sub-vector/data-structure that identifies the execution state in which each feature/activity/operation was observed. As an example, the device processor may generate a behavior vector that includes a “location_background” data field whose value identifies the number or rate that the software application accessed location information when it was operating in a background state. This allows the device processor to analyze this execution state information independent of and/or in parallel with the other observed/monitored activities of the computing device. Generating the behavior vector in this manner also allows the system to aggregate information (e.g., frequency or rate) over time.

In various aspects, the device processor may be configured to generate the behavior vectors to include information that may be input to a decision node in the machine learning classifier to generate an answer to a query regarding the monitored activity.

In various aspects, the device processor may be configured to generate the behavior vectors to include execution information. The execution information may be included in the behavior vector as part of a behavior (e.g., camera used 5 times in 3 second by a background process, camera used 3 times in 3 second by a foreground process, etc.) or as part of an independent feature. In an aspect, the execution state information may be included in the behavior vector as a shadow feature value sub-vector or data structure. In an aspect, the behavior vector may store the shadow feature value sub-vector/data structure in association with the features, activities, tasks for which the execution state is relevant.

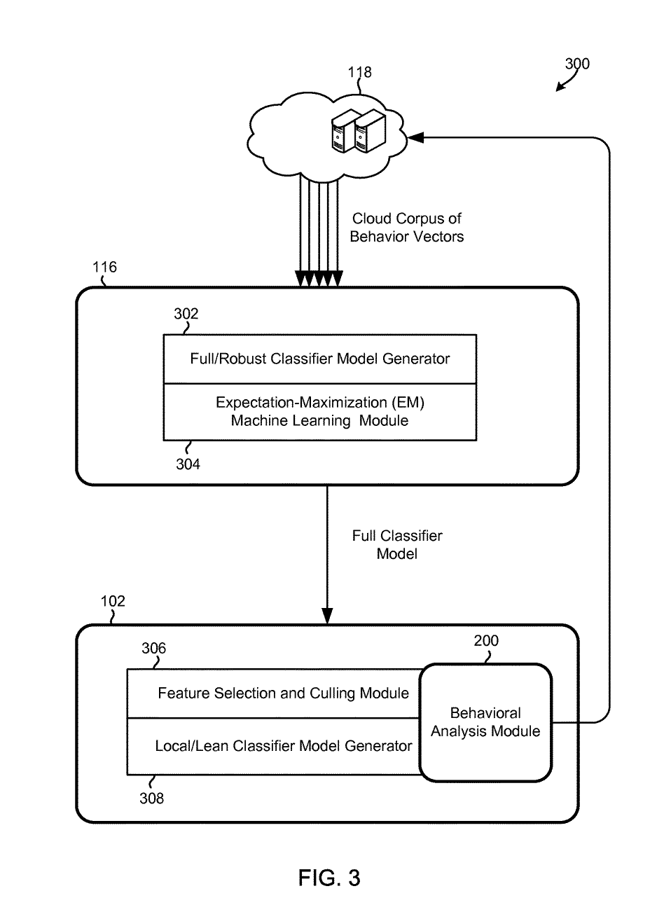

FIG. 3 illustrates example components and information flows in a system 300 that includes a network server 116 configured to work in conjunction with the mobile device 102 to intelligently and efficiently identify performance-degrading mobile device behaviors on the mobile device 102 without consuming an excessive amount of processing, memory, or energy resources of the mobile device 102. In the example illustrated in FIG. 3, the network server 116 includes an expectation-maximization (EM) machine learning module 304 and a full/robust classifier model generator module 302, and the mobile device 102 includes a feature selection and culling module 306, a lean classifier model generator module 308, and a behavior monitoring and analysis module 200 (discussed above with reference to FIG. 2). In the various aspects, any or all of the modules 302-308 may be a real-time online classifier module and/or included in a behavior analyzer module 208 or any combination of the modules illustrated in FIG. 2.

The network server 116 may be configured to receive information on various conditions, features, behaviors, and corrective actions from the cloud service/network 118, and use this information to generate a full classifier model that describes a large corpus of behavior information in a format or structure that can be quickly converted into one or more lean classifier models by the mobile device 102. For example, the full classifier model generator module 302 in the network server 116 may apply conventional machine learning techniques to the cloud corpus of behavior vectors received from the cloud service/network 118 to generate a full classifier model, which may include a finite state machine representation or another information structure that may be expressed as one or more decision nodes and/or as family of boosted decision stumps that collectively identify, describe, test, or evaluate all or many of the features and data points that are relevant to classifying mobile device behavior.

The expectation-maximization (EM) machine learning module 304 may be configured to refine or focus the generated full classifier model by setting the generated full classifier model as the current classifier model, applying behavior vectors that each characterize a known-normal or known-abnormal behavior to the current classifier model to generate analysis results, use the analysis results to determine confidence values for classifying each of the behavior vectors as benign or non-benign (or as normal or abnormal), perform refinement operations, filter the behavior vectors (e.g., by selecting the behavior vectors that have a confidence value that is above a confidence threshold, etc.), generate a new classifier model based on the filtered behavior vectors (e.g., by generating another full classifier model that includes decision nodes that test conditions relevant to the filtered behavior vectors, etc.), set the new classifier model as the current classifier model, and repeat these operations until the accuracy of classifications by the behavior-based security system using the current classifier model exceed a classifier accuracy threshold.

In response to determining that the accuracy in the classification results produced by the behavior-based security system using the current classifier model exceeds a classifier accuracy threshold value, the network server 116 may send the full classifier model to the mobile device 102, which may receive and use the full classifier model in its behavior-based security system to generate a reduced feature classifier model or a family of classifier models of varying levels of complexity or leanness. For example, the feature selection and culling module 306 and lean classifier model generator module 308 may, collectively or individually, use the information included in the full classifier model received from the network server to generate one or more reduced feature classifier models that include a subset of the features and data points included in the full classifier model.

As a further example, the lean classifier model generator module 308 and the feature selection and culling module 306 may individually or collectively cull the relatively robust family of boosted decision stumps included in the finite state machine of the full classifier model received from the network server 116 to generate a reduced feature classifier model that includes a reduced number of boosted decision stumps and/or evaluates a limited number of test conditions. The culling of the robust family of boosted decision stumps may be accomplished by selecting a boosted decision stump, identifying all other boosted decision stumps that test or depend upon the same mobile device feature as the selected decision stump, and adding the selected stump and all the identified other boosted decision stumps that test or depend upon the same mobile device feature to an information structure. This process may be repeated for a limited number of stumps or device features, so that the information structure includes all boosted decision stumps in the full classifier model that test or depend upon a small or limited number of different features or conditions. The mobile device may use this information structure as a lean classifier model in the behavior-based security system to test a limited number of different features or conditions of the mobile device, and to quickly classify a mobile device behavior without consuming an excessive amount of its processing, memory, or energy resources.

The lean classifier model generator module 308 may be further configured to generate classifier models that are specific to the mobile device and to a particular software application or process that may execute on the mobile device. In this manner, one or more lean classifier models may be generated that preferentially or exclusively test features or elements that pertain to the mobile device and that are of particular relevance to the software application. These device- and application-specific/application type-specific lean classifier models may be generated by the lean classifier model generator module 308 in one pass by selecting test conditions that are relevant to the application and pertain to the mobile device. Alternatively, the lean classifier model generator module 308 may generate a device-specific lean classifier model including test conditions pertinent to the mobile device, and from this lean classifier model, generate a further refined model that includes or prioritize those test conditions that are relevant to the application. As a further alternative, the lean classifier model generator module 308 may generate a lean classifier model that is relevant to the application, and remove test conditions that are not relevant to mobile device. For ease of description, the processes of generating a device-specific lean classifier model are described first, followed by processes of generating an application-specific or application-type specific lean classifier model.

The lean classifier model generator module 308 may be configured to generate device-specific classifier models by using device-specific information of the mobile device 102 to identify mobile device-specific features (or test conditions) that are relevant or pertain to classifying a behavior of that specific mobile device 102. The lean classifier model generator module 308 may use this information to generate the lean classifier models that preferentially or exclusively include, test, or depend upon the identified mobile device-specific features or test conditions. The mobile device 102 may use these locally generated lean classifier models to classify the behavior of the mobile device without consuming an excessive amount of its processing, memory, or energy resources. That is, by generating the lean classifier models locally in the mobile device 102 to account for device-specific or device-state-specific features, the various aspects allow the mobile device 102 to focus its monitoring operations on the features or factors that are most important for identifying the source or cause of an undesirable behavior in that specific mobile device 102.

In an aspect, the behavioral analysis module 200 may be configured to use the full classifier model received from the network server 116 to analyze device behaviors. In another aspect, the behavioral analysis module 200 may be configured to use the locally generated lean classifier models to analyze device behaviors. The behavioral analysis module 200 may analyze device behaviors by performing any or all of the operations discussed above with reference to FIG. 2, such as by monitoring activities of a software application to collect behavior information, generating a behavior vector based on the collected behavior information, applying the generated behavior vector to the current classifier model to generate analysis information, and using the analysis information to classify the behavior as benign or non-benign.

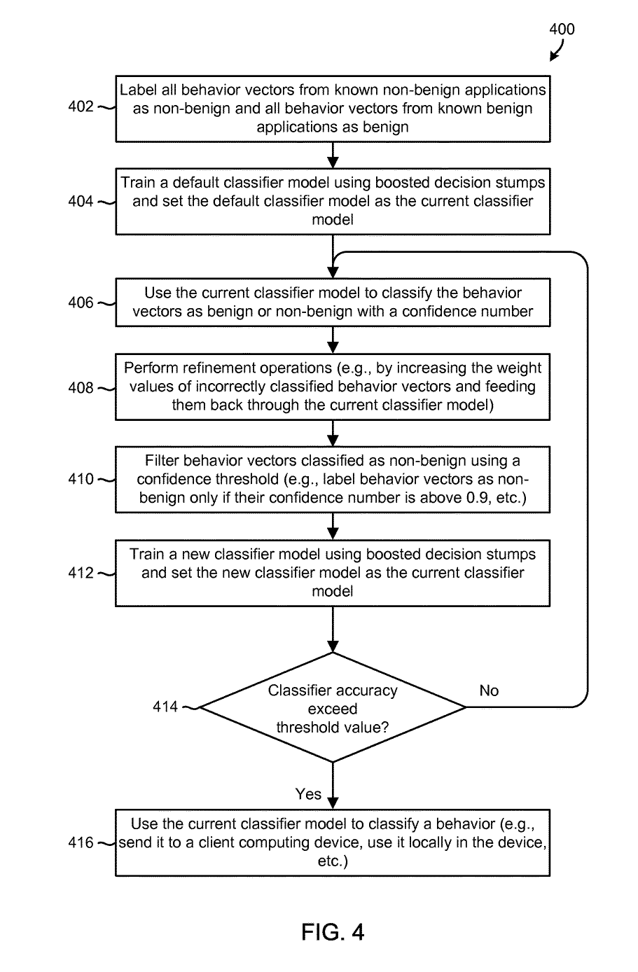

FIG. 4 illustrates a method 400 of using expectation-maximization (EM) machine learning techniques to generate classifier models in accordance with an aspect. In block 402, a processor (or processing core) in a computing device may label all behavior vectors from known non-benign applications as non-benign and label all behavior vectors from known benign applications as benign. In block 404, the processor may train a default classifier model using boosted decision stumps (using existing techniques, etc.) and set the default classifier model as the current classifier model.

In block 406, the processor may use the current classifier model to classify the behavior vectors as benign or non-benign with a confidence number. In block 408, the processor may perform refinement operations, which may include increasing the weight values of incorrectly classified behavior vectors and feeding them back through the current classifier model to generate better or different analysis results.

In block 410, the processor may filter the behavior vectors that were classified as non-benign using a confidence threshold, such as by labeling/classifying behavior vectors as non-benign only if their confidence number is above 0.9 and/or selecting only the behavior vectors classified as non-benign, etc. In block 412, the processor may train a new classifier model using boosted decision stumps, and set the new classifier model as the current classifier model.

In determination block 414, the processor may determine whether classifier accuracy associated with current classifier model (i.e., the accuracy of behavior classifications by the behavior-based security system using the current classifier model) exceeds (e.g., is greater than, less than, equal to, greater than or equal to, etc.) a classifier accuracy threshold value. In response to determining that the classifier accuracy does not exceed the classifier accuracy threshold value (i.e., determination block 414=“No”), the processor may repeat the operations of blocks 406-412.

In response to determining that the classifier accuracy exceeds the classifier accuracy threshold value (i.e., determination block 414=“Yes”), the processor may use the current classifier model to classify a device behavior, which may include sending the current classifier model to a client computing device (e.g., a mobile device) or using the current classifier model to classify a behavior locally in that computing device.

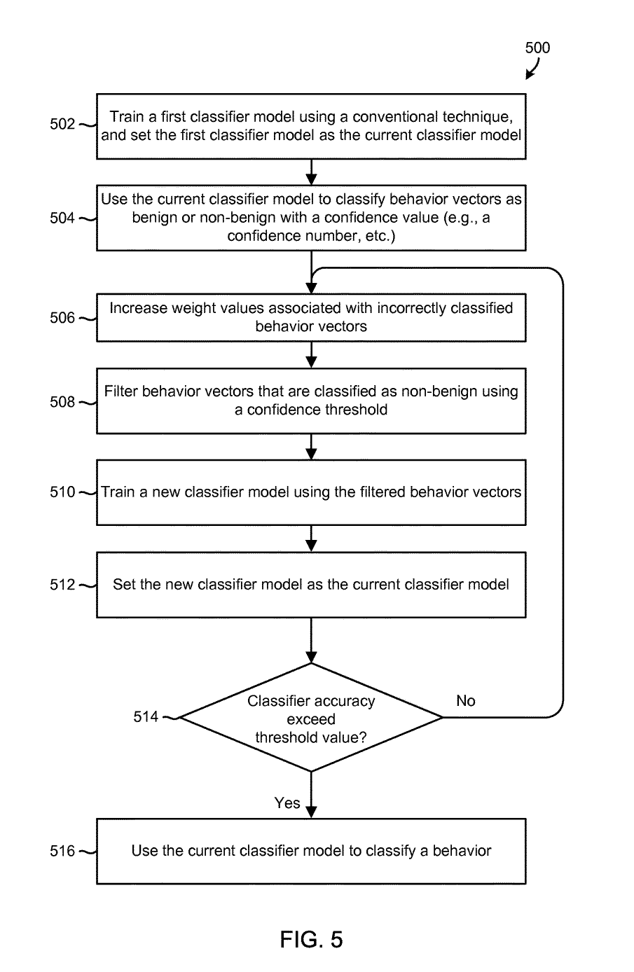

FIG. 5 illustrates a method 500 of using expectation-maximization (EM) machine learning techniques to generate classifier models in accordance with another aspect. In block 502, a processor (or processing core) in a computing device may train a first classifier model using a conventional technique and set the first classifier model as the current classifier model. In block 504, the processor may use the current classifier model to classify behavior vectors as benign or non-benign with a confidence value (e.g., a confidence number, etc.).

In block 506, the processor may increase weight values associated with incorrectly classified behavior vectors. In block 508, the processor may filter behavior vectors that are classified as non-benign using a confidence threshold. In block 510, the processor may train a new classifier model using the filtered behavior vectors. In block 512, the processor may set the new classifier model as the current classifier model.

In determination block 514, the processor may determine whether classifier accuracy associated with current classifier model (i.e., the accuracy of behavior classifications by the behavior-based security system using the current classifier model) exceeds a classifier accuracy threshold value. In response to determining that the classifier accuracy does not exceed the classifier accuracy threshold value (i.e., determination block 514=“No”), the processor may repeat the operations of blocks 506-512. In response to determining that the classifier accuracy exceeds the classifier accuracy threshold value (i.e., determination block 514=“Yes”), the processor may use the current classifier model in the behavior-based security system to classify a device behavior.

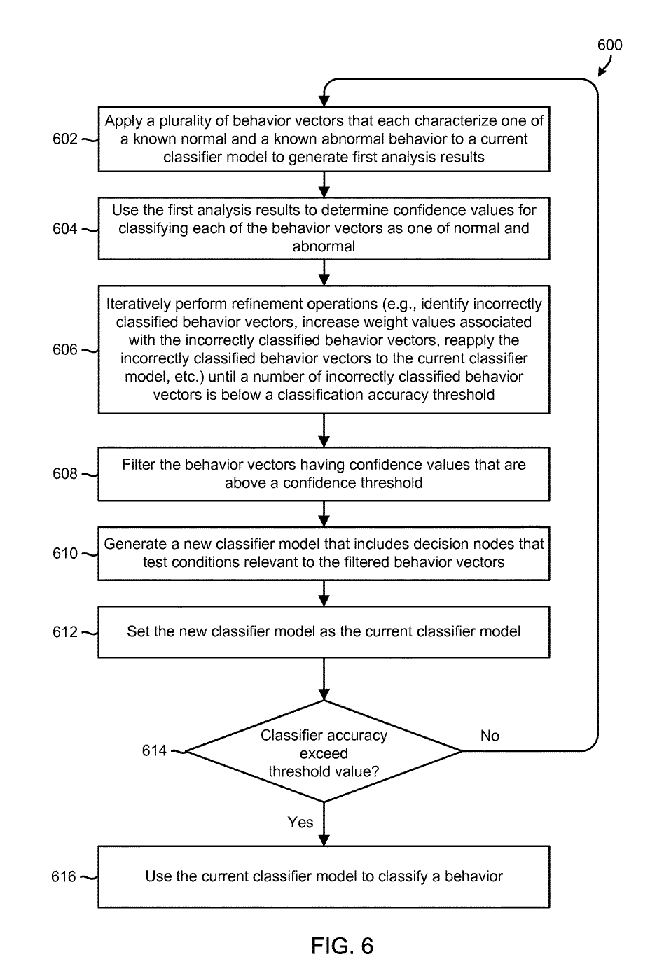

FIG. 6 illustrates a method 600 of using expectation-maximization (EM) machine learning techniques to generate classifier models in accordance with another aspect. In block 602, a processor (or processing core) in a computing device may apply a plurality of behavior vectors that each characterize one of a known normal and a known abnormal behavior to a current classifier model to generate first analysis results. In block 604, the processor may use the first analysis results to determine confidence values for classifying each of the behavior vectors as one of normal and abnormal.

In block 606, the processor may iteratively perform refinement operations (e.g., identify incorrectly classified behavior vectors, increase weight values associated with the incorrectly classified behavior vectors, reapply the incorrectly classified behavior vectors to the current classifier model, etc.) until a number of incorrectly classified behavior vectors is below a classification accuracy threshold.

In block 608, the processor may filter the behavior vectors having confidence values that are above a confidence threshold. In block 610, the processor may generate a new classifier model that includes decision nodes that test conditions relevant to the filtered behavior vectors. In block 612, the processor may set the new classifier model as the current classifier model.

In determination block 614, the processor may determine whether classifier accuracy associated with current classifier model (i.e., the accuracy of behavior classifications by the behavior-based security system using the current classifier model) exceeds a classifier accuracy threshold value. In response to determining that the classifier accuracy does not exceed the classifier accuracy threshold value (i.e., determination block 614=“No”), the processor may repeat the operations of blocks 602-612. In response to determining that the classifier accuracy exceeds the classifier accuracy threshold value (i.e., determination block 614=“Yes”), the processor may use the current classifier model to classify a device behavior.

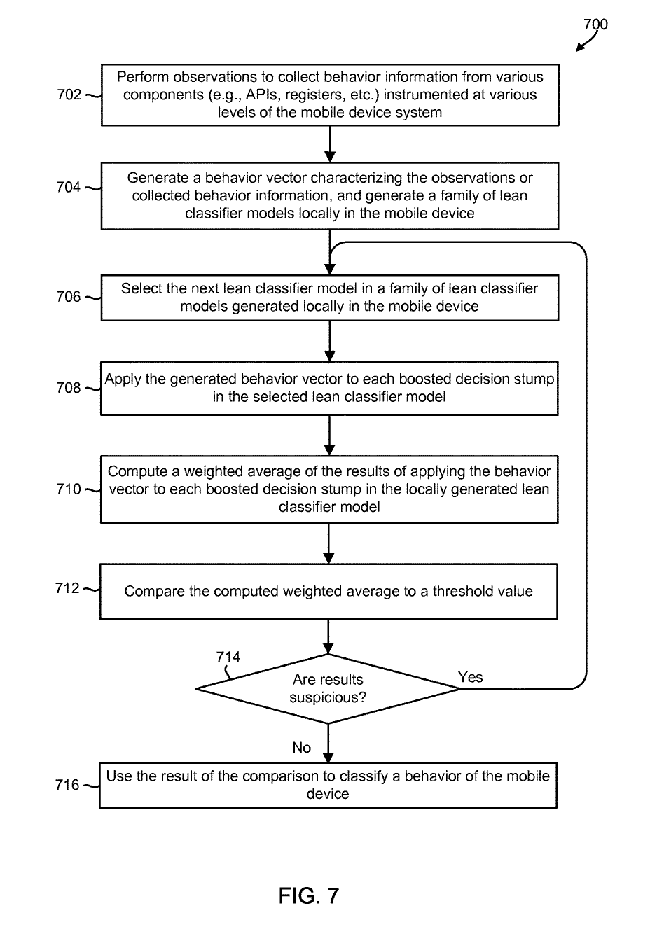

FIG. 7 illustrates an aspect method 700 of using a family of lean classifier model to classify a behavior of the computing device. The method 700 may be performed by a processing core of a mobile or resource constrained computing device. In block 702, the processing core may perform observations to collect behavior information from various components that are instrumented at various levels of the computing device system. In an aspect, this may be accomplished via the behavior observer module 202 discussed above with reference to FIG. 2.

In block 704, the processing core may generate a behavior vector characterizing the observations, the collected behavior information, and/or a computing device behavior. Also in block 704, the processing core may use a full classifier model received from a network server to generate a lean classifier model or a family of lean classifier models of varying levels of complexity (or “leanness”). To accomplish this, the processing core may cull a family of boosted decision stumps included in the full classifier model to generate lean classifier models that include a reduced number of boosted decision stumps and/or evaluate a limited number of test conditions.

In block 706, the processing core may select the leanest classifier in the family of lean classifier models (i.e., the model based on the fewest number of different computing device states, features, behaviors, or conditions) that has not yet been evaluated or applied by the computing device. In an aspect, this may be accomplished by the processing core selecting the first classifier model in an ordered list of classifier models.

In block 708, the processing core may apply collected behavior information or behavior vectors to each boosted decision stump in the selected lean classifier model. Because boosted decision stumps are binary decisions and the lean classifier model is generated by selecting many binary decisions that are based on the same test condition, the process of applying a behavior vector to the boosted decision stumps in the lean classifier model may be performed in a parallel operation. Alternatively, the behavior vector applied in block 708 may be truncated or filtered to just include the limited number of test condition parameters included in the lean classifier model, thereby further reducing the computational effort in applying the model.

In block 710, the processing core may compute or determine a weighted average of the results of applying the collected behavior information to each boosted decision stump in the lean classifier model. In block 712, the processing core may compare the computed weighted average to a threshold value.

In determination block 714, the processing core may determine whether the results of this comparison and/or the results generated by applying the selected lean classifier model are suspicious. For example, the processing core may determine whether these results may be used to classify a behavior as either malicious or benign with a high degree of confidence, and if not treat the behavior as suspicious.

In response to determining that the results are suspicious (e.g., determination block 714=“Yes”), the processing core may repeat the operations in blocks 706-712 to select and apply a stronger (i.e., less lean) classifier model that evaluates more device states, features, behaviors, or conditions until the behavior is classified as malicious or benign with a high degree of confidence. In response to determining that the results are not suspicious (e.g., determination block 714=“No”), such as by determining that the behavior can be classified as either malicious or benign with a high degree of confidence the processing core may use the result of the comparison generated in block 712 to classify a behavior of the computing device as benign or potentially malicious in block 716.

In an alternative aspect method, the operations described above may be accomplished by sequentially selecting a boosted decision stump that is not already in the lean classifier model, identifying all other boosted decision stumps that depend upon the same computing device state, feature, behavior, or condition as the selected decision stump (and thus can be applied based upon one determination result), including in the lean classifier model the selected and all identified other boosted decision stumps that that depend upon the same computing device state, feature, behavior, or condition, and repeating the process for a number of times equal to the determined number of test conditions. Because all boosted decision stumps that depend on the same test condition as the selected boosted decision stump are added to the lean classifier model each time, limiting the number of times this process is performed will limit the number of test conditions included in the lean classifier model.

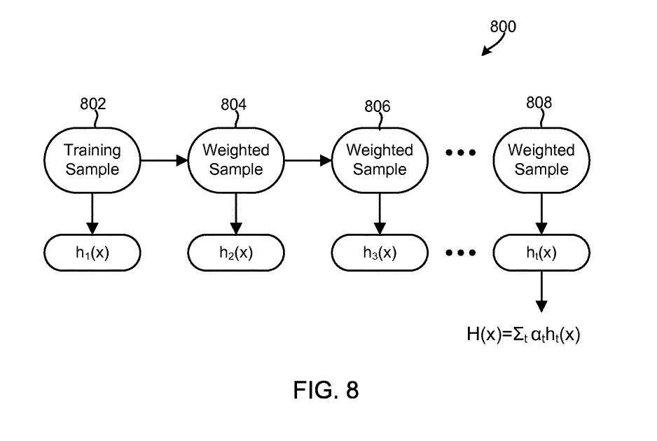

FIG. 8 illustrates an example boosting method 800 suitable for generating a boosted decision tree/classifier that is suitable for use in accordance with various aspects. In block 802, a processor may generate and/or execute a decision tree/classifier, collect a training sample from the execution of the decision tree/classifier, and generate a new classifier model (h1(x)) based on the training sample. The training sample may include information collected from previous observations or analysis of computing device behaviors, software applications, or processes in the computing device. The training sample and/or new classifier model (h1(x)) may be generated based the types of question or test conditions included in previous classifiers and/or based on accuracy or performance characteristics collected from the execution/application of previous data/behavior models or classifiers in a classifier module of a behavior analyzer module 208. In block 804, the processor may boost (or increase) the weight of the entries that were misclassified by the generated decision tree/classifier (h1(x)) to generate a second new tree/classifier (h2(x)). In an aspect, the training sample and/or new classifier model (h2(x)) may be generated based on the mistake rate of a previous execution or use (h1(x)) of a classifier. In an aspect, the training sample and/or new classifier model (h2(x)) may be generated based on attributes determined to have that contributed to the mistake rate or the misclassification of data points in the previous execution or use of a classifier.

In an aspect, the misclassified entries may be weighted based on their relatively accuracy or effectiveness. In block 806, the processor may boost (or increase) the weight of the entries that were misclassified by the generated second tree/classifier (h2(x)) to generate a third new tree/classifier (h3(x)). In block 808, the operations of blocks 804-806 may be repeated to generate “t” number of new tree/classifiers (hₜ(x)).

By boosting or increasing the weight of the entries that were misclassified by the first decision tree/classifier (h1(x)), the second tree/classifier (h2(x)) may more accurately classify the entities that were misclassified by the first decision tree/classifier (h1(x)), but may also misclassify some of the entities that where correctly classified by the first decision tree/classifier (h1(x)). Similarly, the third tree/classifier (h3(x)) may more accurately classify the entities that were misclassified by the second decision tree/classifier (h2(x)) and misclassify some of the entities that where correctly classified by the second decision tree/classifier (h2(x)). That is, generating the family of tree/classifiers h1(x)-hₜ(x) may not result in a system that converges as a whole, but results in a number of decision trees/classifiers that may be executed in parallel.

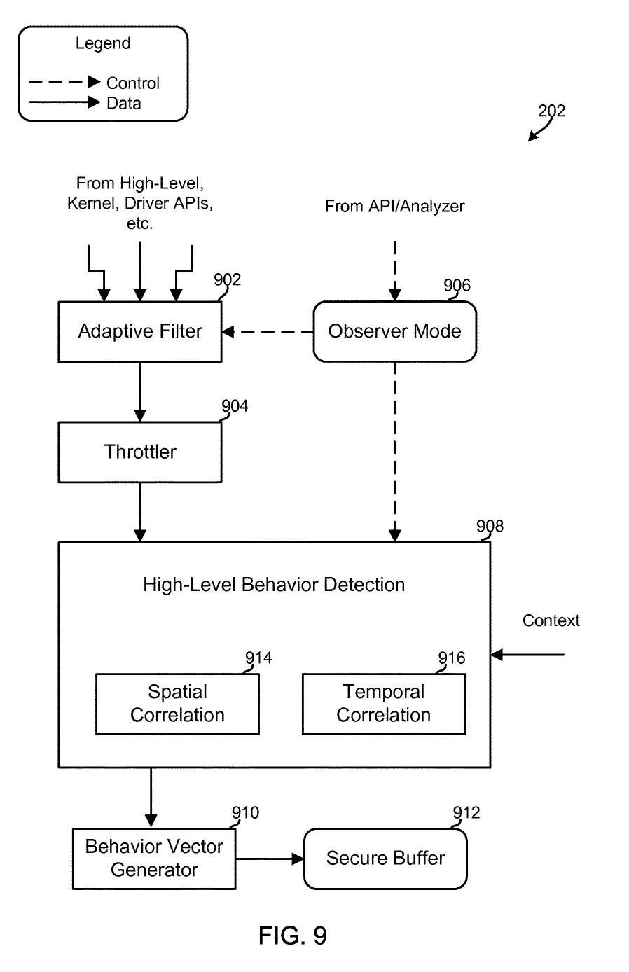

FIG. 9 illustrates example logical components and information flows in a behavior observer module 202 of a computing system configured to perform dynamic and adaptive observations in accordance with an aspect. The behavior observer module 202 may include an adaptive filter module 902, a throttle module 904, an observer mode module 906, a high-level behavior detection module 908, a behavior vector generator 910, and a secure buffer 912. The high-level behavior detection module 908 may include a spatial correlation module 914 and a temporal correlation module 916.

The observer mode module 906 may receive control information from various sources, which may include an analyzer unit (e.g., the behavior analyzer module 208 described above with reference to FIG. 2) and/or an application API. The observer mode module 906 may send control information pertaining to various observer modes to the adaptive filter module 902 and the high-level behavior detection module 908.

The adaptive filter module 902 may receive data/information from multiple sources, and intelligently filter the received information to generate a smaller subset of information selected from the received information. This filter may be adapted based on information or control received from the analyzer module, or a higher-level process communicating through an API. The filtered information may be sent to the throttle module 904, which may be responsible for controlling the amount of information flowing from the filter to ensure that the high-level behavior detection module 908 does not become flooded or overloaded with requests or information.

The high-level behavior detection module 908 may receive data/information from the throttle module 904, control information from the observer mode module 906, and context information from other components of the computing device. The high-level behavior detection module 908 may use the received information to perform spatial and temporal correlations to detect or identify high level behaviors that may cause the device to perform at sub-optimal levels. The results of the spatial and temporal correlations may be sent to the behavior vector generator 910, which may receive the correlation information and generate a behavior vector that describes the behaviors of a particular process, application, or sub-system. In an aspect, the behavior vector generator 910 may generate the behavior vector such that each high-level behavior of a particular process, application, or sub-system is an element of the behavior vector. In an aspect, the generated behavior vector may be stored in a secure buffer 912. Examples of high-level behavior detection may include detection of the existence of a particular event, the amount or frequency of another event, the relationship between multiple events, the order in which events occur, time differences between the occurrence of certain events, etc.

In the various aspects, the behavior observer module 202 may perform adaptive observations and control the observation granularity. That is, the behavior observer module 202 may dynamically identify the relevant behaviors that are to be observed, and dynamically determine the level of detail at which the identified behaviors are to be observed. In this manner, the behavior observer module 202 enables the system to monitor the behaviors of the computing device at various levels (e.g., multiple coarse and fine levels). The behavior observer module 202 may enable the system to adapt to what is being observed. The behavior observer module 202 may enable the system to dynamically change the factors/behaviors being observed based on a focused subset of information, which may be obtained from a wide verity of sources.

As discussed above, the behavior observer module 202 may perform adaptive observation techniques and control the observation granularity based on information received from a variety of sources. For example, the high-level behavior detection module 908 may receive information from the throttle module 904, the observer mode module 906, and context information received from other components (e.g., sensors) of the computing device. As an example, a high-level behavior detection module 908 performing temporal correlations might detect that a camera has been used and that the computing device is attempting to upload the picture to a server. The high-level behavior detection module 908 may also perform spatial correlations to determine whether an application on the computing device took the picture while the device was holstered and attached to the user's belt. The high-level behavior detection module 908 may determine whether this detected high-level behavior (e.g., usage of the camera while holstered) is a behavior that is acceptable or common, which may be achieved by comparing the current behavior with past behaviors of the computing device and/or accessing information collected from a plurality of devices (e.g., information received from a crowd-sourcing server). Since taking pictures and uploading them to a server while holstered is an unusual behavior (as may be determined from observed normal behaviors in the context of being holstered), in this situation the high-level behavior detection module 908 may recognize this as a potentially threatening behavior and initiate an appropriate response (e.g., shutting off the camera, sounding an alarm, etc.).

In an aspect, the behavior observer module 202 may be implemented in multiple parts.

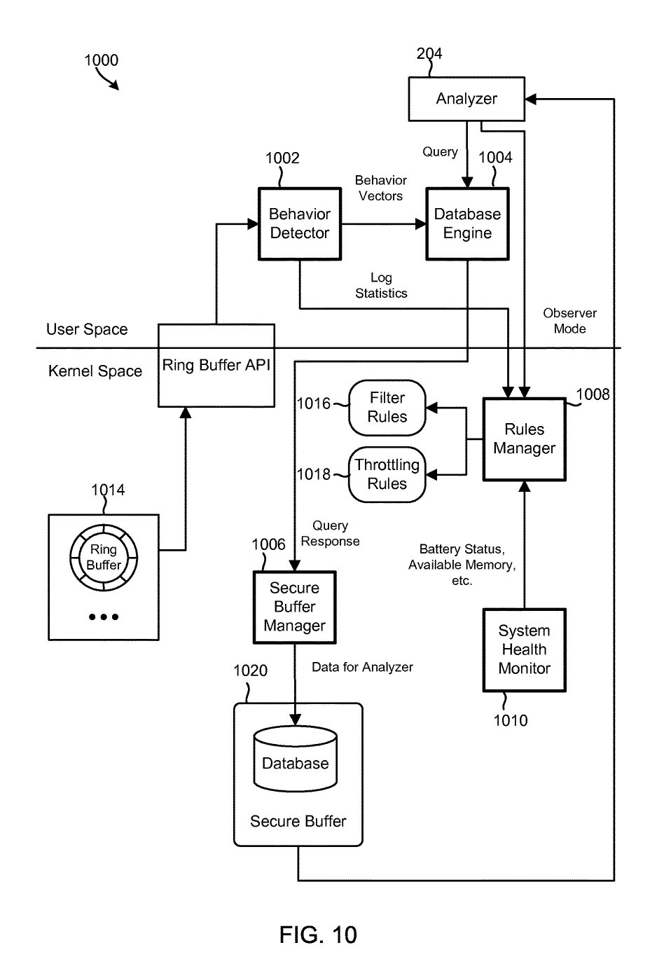

FIG. 10 illustrates in more detail logical components and information flows in a computing system 1000 implementing an aspect observer daemon. In the example illustrated in FIG. 10, the computing system 1000 includes a behavior detector 1002 module, a database engine 1004 module, and a behavior analyzer module 208 in the user space, and a ring buffer 1014, a filter rules 1016 module, a throttling rules 1018 module, and a secure buffer 1020 in the kernel space. The computing system 1000 may further include an observer daemon that includes the behavior detector 1002 and the database engine 1004 in the user space, and the secure buffer manager 1006, the rules manager 1008, and the system health monitor 1010 in the kernel space.

The various aspects may provide cross-layer observations on computing devices encompassing webkit, SDK, NDK, kernel, drivers, and hardware in order to characterize system behavior. The behavior observations may be made in real time.

The observer module may perform adaptive observation techniques and control the observation granularity. As discussed above, there are a large number (i.e., thousands) of factors that could contribute to the computing device's degradation, and it may not be feasible to monitor/observe all of the different factors that may contribute to the degradation of the device's performance. To overcome this, the various aspects dynamically identify the relevant behaviors that are to be observed, and dynamically determine the level of detail at which the identified behaviors are to be observed.

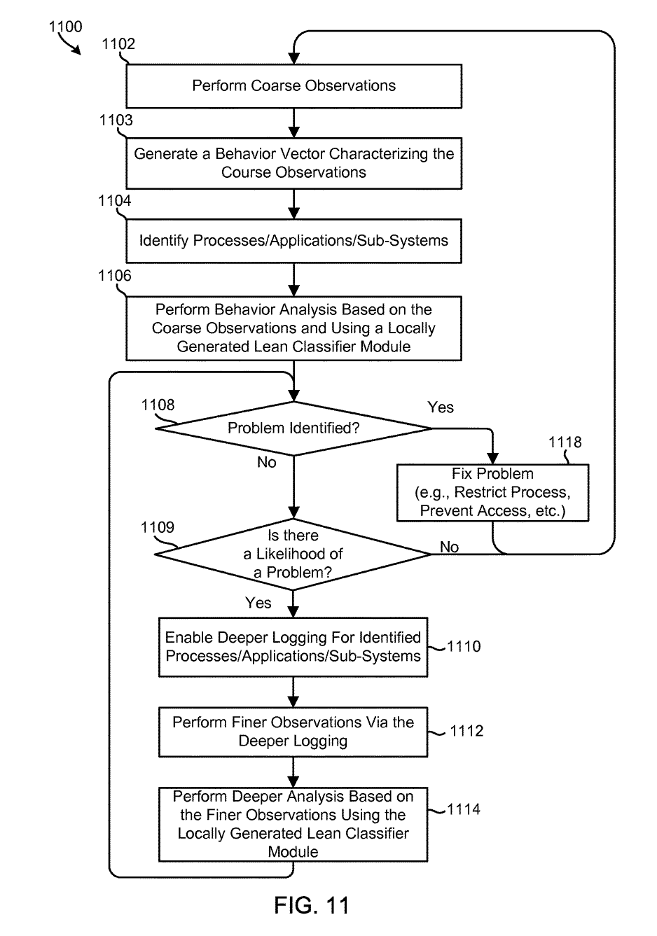

FIG. 11 illustrates an example method 1100 for performing dynamic and adaptive observations in accordance with an aspect. In block 1102, the device processor may perform coarse observations by monitoring/observing a subset of a large number of factors/behaviors that could contribute to the computing device's degradation. In block 1103, the device processor may generate a behavior vector characterizing the coarse observations and/or the computing device behavior based on the coarse observations.

In block 1104, the device processor may identify subsystems, processes, and/or applications associated with the coarse observations that may potentially contribute to the computing device's degradation. This may be achieved, for example, by comparing information received from multiple sources with contextual information received from sensors of the computing device. In block 1106, the device processor may perform behavioral analysis operations based on the coarse observations. In an aspect, as part of blocks 1103 and 1104, the device processor may perform one or more of the operations discussed above with reference to FIGS. 2-10.

In determination block 1108, the device processor may determine whether suspicious behaviors or potential problems can be identified and corrected based on the results of the behavioral analysis. In response to determining that the suspicious behaviors or potential problems can be identified and corrected based on the results of the behavioral analysis (i.e., determination block 1108=“Yes”), the processor may initiate a process to correct the behavior and return to block 1102 to perform additional coarse observations in block 1118.

In response to determining that the suspicious behaviors or potential problems cannot be identified and/or corrected based on the results of the behavioral analysis (i.e., determination block 1108=“No”), the device processor may determine whether there is a likelihood of a problem in determination block 1109. In an aspect, the device processor may determine that there is a likelihood of a problem by computing a probability of the computing device encountering potential problems and/or engaging in suspicious behaviors, and determining whether the computed probability is greater than a predetermined threshold.

In response to determining that the computed probability is not greater than the predetermined threshold and/or there is not a likelihood that suspicious behaviors or potential problems exist and/or are detectable (i.e., determination block 1109=“No”), the processor may return to performing additional coarse observations in block 1102.

In response to determining that there is a likelihood that suspicious behaviors or potential problems exist and/or are detectable (i.e., determination block 1109=“Yes”), the device processor may perform deeper logging/observations or final logging on the identified subsystems, processes or applications in block 1110. In block 1112, the device processor may perform deeper and more detailed observations on the identified subsystems, processes or applications. In block 1114, the device processor may perform further and/or deeper behavioral analysis based on the deeper and more detailed observations.

In determination block 1108, the device processor may again determine whether the suspicious behaviors or potential problems can be identified and corrected based on the results of the deeper behavioral analysis. In response to determining that the suspicious behaviors or potential problems cannot be identified and corrected based on the results of the deeper behavioral analysis (i.e., determination block 1108=“No”), the processor may repeat the operations in blocks 1110-1114 until the level of detail is fine enough to identify the problem or until it is determined that the problem cannot be identified with additional detail or that no problem exists.

In response to determining that the suspicious behaviors or potential problems can be identified and corrected based on the results of the deeper behavioral analysis (i.e., determination block 1108=“Yes”), the device processor may perform operations to correct the problem/behavior in block 1118, and return to performing additional coarse observations in block 1102.

In an aspect, as part of blocks 1102-1118 of the method 1100, the device processor may perform real-time behavior analysis of the system's behaviors to identify suspicious behaviors from limited and coarse observations, to dynamically determine the behaviors to observe in greater detail, and to dynamically determine the precise level of detail required for the observations. This enables the device processor to efficiently identify and prevent problems from occurring, without requiring the use of a large amount of processor, memory, or battery resources on the device.

The various aspects improve upon existing solutions by using behavior analysis and/or machine learning techniques (as opposed to a permissions, policy, or rules-based approaches) to monitor and analyze the collective behavior of a select group of software applications. The use of behavior analysis or machine learning techniques is important because modern computing devices are highly configurable and complex systems, and the factors that are most important for determining whether software applications are colluding may be different in each device. Further, different combinations of device features/factors may require an analysis in each device in order for that device to determine whether software applications are colluding. Yet, the precise combination of features/factors that require monitoring and analysis often can only be determined using information obtained from the specific computing device in which the activity is performed and at the time the activity is underway. For these and other reasons, existing solutions are not adequate for monitoring, detecting, and characterizing the collective behavior of, or the relationships between, a plurality of software applications in the computing device, in real-time, while the behavior is underway, and without consuming a significant amount of the computing device's processing, memory, or power resources.

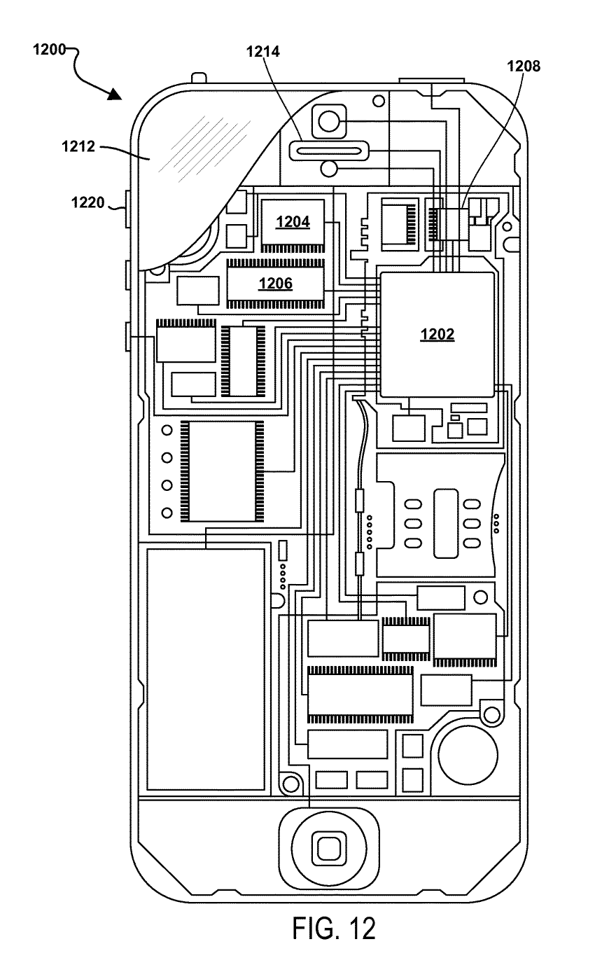

The various aspects (including, but not limited to, aspects discussed above with reference to FIGS. 1-11) may be implemented on a variety of computing devices, an example of which is illustrated in FIG. 12 in the form of a smartphone. A smartphone 1200 may include a processor 1202 coupled to internal memory 1204, a display 1212, and to a speaker 1214. Additionally, the smartphone 1200 may include an antenna for sending and receiving electromagnetic radiation that may be connected to a wireless data link and/or cellular telephone transceiver 1208 coupled to the processor 1202. Smartphones 1200 typically also include menu selection buttons or rocker switches 1220 for receiving user inputs.

A typical smartphone 1200 also includes a sound encoding/decoding (CODEC) circuit 1206, which digitizes sound received from a microphone into data packets suitable for wireless transmission and decodes received sound data packets to generate analog signals that are provided to the speaker to generate sound. Also, one or more of the processor 1202, wireless transceiver 1208 and CODEC 1206 may include a digital signal processor (DSP) circuit (not shown separately). In an aspect, the processor 1202 may be included in, a system-on-chip (SOC), such as the SOC 100 illustrated in FIG. 1. In an aspect, the processor 1202 may be the application processor 108 illustrated in FIG. 1. In an aspect, the processor 1202 may be a processing core (e.g., IP core, CPU core, etc.).

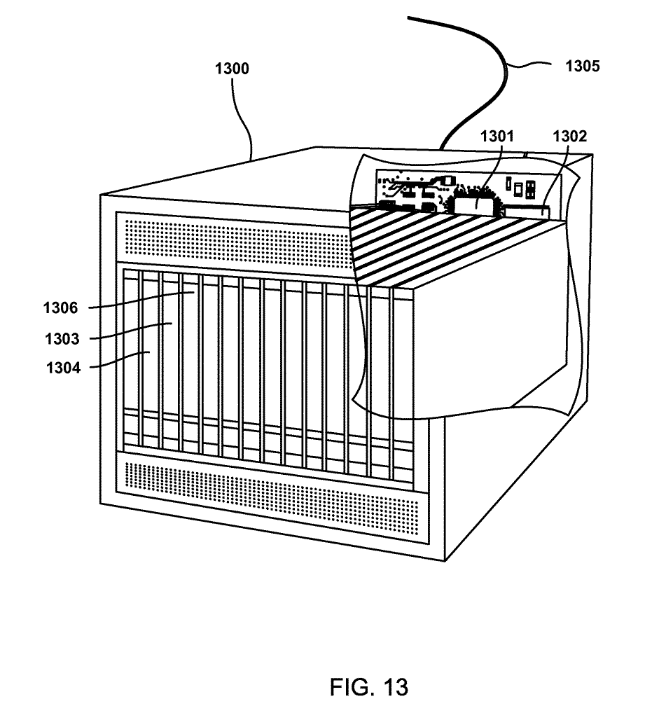

Portions of the aspect methods may be accomplished in a client-server architecture with some of the processing occurring in a server, such as maintaining databases of normal operational behaviors, which may be accessed by a device processor while executing the aspect methods. Such aspects may be implemented on any of a variety of commercially available server devices, such as the server 1300 illustrated in FIG. 13. Such a server 1300 typically includes a processor 1301 coupled to volatile memory 1302 and a large capacity nonvolatile memory, such as a disk drive 1303. The server 1300 may also include a floppy disc drive, compact disc (CD) or DVD disc drive 1304 coupled to the processor 1301. The server 1300 may also include network access ports 1306 coupled to the processor 1301 for establishing data connections with a network 1305, such as a local area network coupled to other broadcast system computers and servers.

The processors 1202, 1301 may be any programmable microprocessor, microcomputer or multiple processor chip or chips that can be configured by software instructions (applications) to perform a variety of functions, including the functions of the various aspects described below. In some mobile devices, multiple processors 1202 may be provided, such as one processor dedicated to wireless communication functions and one processor dedicated to running other applications. Typically, software applications may be stored in the internal memory 1204, 1302, 1303 before they are accessed and loaded into the processor 1202, 1301. The processor 1202, 1301 may include internal memory sufficient to store the application software instructions.

As used in this application, the terms “component,” “module,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many mobile computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples, and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of generating behavior classifier models for use in a behavior monitoring system of a computing device, comprising:
applying a plurality of behavior vectors that each characterize one of a known normal and a known abnormal behavior to a current classifier model to generate first analysis results;
using the first analysis results to determine confidence values for classifying each of the plurality of behavior vectors as one of normal and abnormal;
filtering behavior vectors having confidence values that are above a confidence threshold;
generating a new classifier model that includes decision nodes that test conditions relevant to the filtered behavior vectors;
setting the new classifier model as the current classifier model; and
using the current classifier model in the behavior monitoring system to classify a computing device behavior.

2. The method of claim 1, further comprising:
prior to using the current classifier model to classify a behavior, iteratively performing operations of applying the plurality of behavior vectors to the current classifier model to generate the first analysis results, using the first analysis results to determine confidence values for classifying each of the plurality of behavior vectors as one of normal and abnormal, filtering behavior vectors having confidence values that are above a confidence threshold, generating a new classifier model that includes decision nodes that test conditions relevant to the filtered behavior vectors, and setting the new classifier model as the current classifier model until an accuracy of behavior classifications by the behavior monitoring system using the current classifier model exceeds a classifier accuracy threshold.

3. The method of claim 1, further comprising:
prior to filtering behavior vectors, performing refinement operations that include identifying incorrectly classified behavior vectors, determining an adjusted weight value by increasing a weight value associated with the incorrectly classified behavior vectors, generating a new classifier model based on the plurality of behavior vectors and the adjusted weight value.

4. The method of claim 3, further comprising:
iteratively performing the refinement operations to repeatedly regenerate the new classifier model until a classifier accuracy value associated with the new classifier model exceeds a threshold value.

5. The method of claim 1, wherein using the current classifier model in the behavior monitoring system to classify a computing device behavior comprises:
monitoring activities of a software application to collect behavior information;
generating a behavior vector based on the collected behavior information;
applying the generated behavior vector to the current classifier model to generate analysis information; and
using the analysis information to classify the computing device behavior as benign or non-benign.

6. The method of claim 1, wherein using the current classifier model in the behavior monitoring system to classify a computing device behavior comprises classifying the computing device behavior as normal or abnormal.

7. The method of claim 1, further comprising sending the current classifier model to a mobile computing device.

8. The method of claim 1, wherein using the current classifier model in the behavior monitoring system to classify a computing device behavior comprises:
receiving the current classifier model in a mobile computing device; and
using the received current classifier model in a behavior monitoring system of the mobile computing device to classify the computing device behavior.

9. The method of claim 8, wherein using the received current classifier model in a behavior monitoring system of the mobile computing device to classify the computing device behavior comprises:
identifying mobile device features used by a software application operating on the mobile computing device;
identifying decision nodes in the received current classifier model that evaluate the identified mobile device features;
generating a local classifier model in the mobile device that includes and prioritizes the identified decision nodes; and
using the locally generated classifier model to classify the computing device behavior.

10. A computing device, comprising:
means for applying a plurality of behavior vectors that each characterize one of a known normal and a known abnormal behavior to a current classifier model to generate first analysis results;
means for using the first analysis results to determine confidence values for classifying each of the plurality of behavior vectors as one of normal and abnormal;
means for filtering behavior vectors having confidence values that are above a confidence threshold;
means for generating a new classifier model that includes decision nodes that test conditions relevant to the filtered behavior vectors;
means for setting the new classifier model as the current classifier model; and
means for using the current classifier model to classify a computing device behavior.

11. The computing device of claim 10, further comprising:
means for iteratively performing, prior to using the current classifier model to classify a behavior, operations of applying the plurality of behavior vectors to the current classifier model to generate the first analysis results, using the first analysis results to determine confidence values for classifying each of the plurality of behavior vectors as one of normal and abnormal, filtering behavior vectors having confidence values that are above a confidence threshold, generating a new classifier model that includes decision nodes that test conditions relevant to the filtered behavior vectors, and setting the new classifier model as the current classifier model until an accuracy of behavior classifications using the current classifier model exceeds a classifier accuracy threshold.

12. The computing device of claim 10, further comprising:
means for performing refinement operations prior to filtering behavior vectors, the refinement operations including identifying incorrectly classified behavior vectors, determining an adjusted weight value by increasing a weight value associated with the incorrectly classified behavior vectors, generating a new classifier model based on the plurality of behavior vectors and the adjusted weight value.

13. The computing device of claim 12, further comprising:
means for iteratively performing the refinement operations to repeatedly regenerate the new classifier model until a classifier accuracy value associated with the new classifier model exceeds a threshold value.

14. The computing device of claim 10, wherein means for using the current classifier model to classify a computing device behavior comprises:
means for monitoring activities of a software application to collect behavior information;
means for generating a behavior vector based on the collected behavior information;
means for applying the generated behavior vector to the current classifier model to generate analysis information; and
means for using the analysis information to classify the computing device behavior as benign or non-benign.

15. The computing device of claim 10, wherein means for using the current classifier model to classify a computing device behavior comprises means for classifying the computing device behavior as normal or abnormal.

16. The computing device of claim 10, wherein means for using the current classifier model to classify the computing device behavior comprises:
means for identifying device features used by a software application operating on the mobile computing device;
means for identifying decision nodes in the received classifier model that evaluate the identified mobile device features;
means for generating a local classifier model that includes and prioritizes the identified decision nodes; and
means for using the locally generated classifier model to classify the computing device behavior.

17. A computing device, comprising:
a processor configured with processor-executable instructions to perform operations comprising:
applying a plurality of behavior vectors that each characterize one of a known normal and a known abnormal behavior to a current classifier model to generate first analysis results;
using the first analysis results to determine confidence values for classifying each of the plurality of behavior vectors as one of normal and abnormal;
filtering behavior vectors having confidence values that are above a confidence threshold;
generating a new classifier model that includes decision nodes that test conditions relevant to the filtered behavior vectors;
setting the new classifier model as the current classifier model; and
using the current classifier model in a behavior monitoring system to classify a computing device behavior.

18. The computing device of claim 17, wherein the processor is configured with processor-executable instructions to perform operations further comprising:
prior to using the current classifier model to classify a behavior, iteratively performing operations of applying the plurality of behavior vectors to the current classifier model to generate the first analysis results, using the first analysis results to determine confidence values for classifying each of the plurality of behavior vectors as one of normal and abnormal, filtering behavior vectors having confidence values that are above a confidence threshold, generating a new classifier model that includes decision nodes that test conditions relevant to the filtered behavior vectors, and setting the new classifier model as the current classifier model until an accuracy of behavior classifications by the behavior monitoring system using the current classifier model exceeds a classifier accuracy threshold.

19. The computing device of claim 17, wherein the processor is configured with processor-executable instructions to perform operations further comprising:
prior to filtering behavior vectors, performing refinement operations that include identifying incorrectly classified behavior vectors, determining an adjusted weight value by increasing a weight value associated with the incorrectly classified behavior vectors, generating a new classifier model based on the plurality of behavior vectors and the adjusted weight value.

20. The computing device of claim 19, wherein the processor is configured with processor-executable instructions to perform operations further comprising:
iteratively performing the refinement operations to repeatedly regenerate the new classifier model until a classifier accuracy value associated with the new classifier model exceeds a threshold value.

21. The computing device of claim 17, wherein the processor is configured with processor-executable instructions to perform operations such that using the current classifier model in the behavior monitoring system to classify a computing device behavior comprises:
monitoring activities of a software application to collect behavior information;
generating a behavior vector based on the collected behavior information;
applying the generated behavior vector to the current classifier model to generate analysis information; and
using the analysis information to classify the computing device behavior as benign or non-benign.

22. The computing device of claim 17, wherein the processor is configured with processor-executable instructions to perform operations such that using the current classifier model in the behavior monitoring system to classify a computing device behavior comprises classifying the computing device behavior as normal or abnormal.

23. The computing device of claim 17, wherein the processor is configured with processor-executable instructions to perform operations such that using the current classifier model in the behavior monitoring system to classify a computing device behavior comprises:
identifying device features used by a software application operating on the mobile computing device;
identifying decision nodes in the received classifier model that evaluate the identified mobile device features;
generating a local classifier model that includes and prioritizes the identified decision nodes; and
using the locally generated classifier model to classify a device behavior.

24. A non-transitory computer readable storage medium having stored thereon processor-executable software instructions configured to cause a processor of a computing device to perform operations comprising:
applying a plurality of behavior vectors that each characterize one of a known normal and a known abnormal behavior to a current classifier model to generate first analysis results;
using the first analysis results to determine confidence values for classifying each of the plurality of behavior vectors as one of normal and abnormal;
filtering behavior vectors having confidence values that are above a confidence threshold;
generating a new classifier model that includes decision nodes that test conditions relevant to the filtered behavior vectors;
setting the new classifier model as the current classifier model; and
using the current classifier model in a behavior monitoring system to classify a computing device behavior.

25. The non-transitory computer readable storage medium of claim 24, wherein the stored processor-executable instructions are configured to cause a processor to perform operations further comprising:
prior to using the current classifier model to classify a behavior, iteratively performing operations of applying the plurality of behavior vectors to the current classifier model to generate the first analysis results, using the first analysis results to determine confidence values for classifying each of the plurality of behavior vectors as one of normal and abnormal, filtering behavior vectors having confidence values that are above a confidence threshold, generating a new classifier model that includes decision nodes that test conditions relevant to the filtered behavior vectors, and setting the new classifier model as the current classifier model until an accuracy of behavior classifications by the behavior monitoring system using the current classifier model exceeds a classifier accuracy threshold.

26. The non-transitory computer readable storage medium of claim 24, wherein the stored processor-executable instructions are configured to cause a processor to perform operations further comprising:
prior to filtering behavior vectors, performing refinement operations that include identifying incorrectly classified behavior vectors, determining an adjusted weight value by increasing a weight value associated with the incorrectly classified behavior vectors, generating a new classifier model based on the plurality of behavior vectors and the adjusted weight value.

27. The non-transitory computer readable storage medium of claim 24, wherein the stored processor-executable instructions are configured to cause a processor to perform operations further comprising:
iteratively performing refinement operations to repeatedly regenerate the new classifier model until a classifier accuracy value associated with the new classifier model exceeds a threshold value.

28. The non-transitory computer readable storage medium of claim 24, wherein the stored processor-executable instructions are configured to cause a processor to perform operations such that using the current classifier model in the behavior monitoring system to classify the computing device behavior comprises:
monitoring activities of a software application to collect behavior information;
generating a behavior vector based on the collected behavior information;
applying the generated behavior vector to the current classifier model to generate analysis information; and
using the analysis information to classify the computing device behavior as benign or non-benign.

29. The non-transitory computer readable storage medium of claim 24, wherein the stored processor-executable instructions are configured to cause a processor to perform operations such that using the current classifier model in the behavior monitoring system to classify the computing device behavior comprises classifying the computing device behavior as normal or abnormal.

30. The non-transitory computer readable storage medium of claim 24, wherein the stored processor-executable instructions are configured to cause a processor to perform operations such that using the current classifier model in the behavior monitoring system to classify the computing device behavior comprises:
identifying device features used by a software application operating on the mobile computing device;
identifying decision nodes in the received classifier model that evaluate the identified mobile device features;
generating a local classifier model that includes and prioritizes the identified decision nodes; and
using the locally generated classifier model to classify the computing device behavior.
